(19) United States
(12) Patent Application Publication
(10) Pub. No.: US 2026/0341197 A1
(43) Pub. Date: Oct. 29, 2026

(54) LIGHT EMITTING DIODE DISPLAY APPARATUS

(71) Applicant: LG Display Co., Ltd., Seoul (KR)

(72) Inventors: SeongHwan JU, Paju-si (KR); HyunSu HAN, Paju-si (KR); Sangmin PARK, Paju-si (KR)

(73) Assignee: LG Display Co., Ltd., Seoul (KR)

(21) Appl. No.: 19/432,547

(22) Filed: Dec. 24, 2025

(30) Foreign Application Priority Data
Dec. 31, 2024 (KR) 10-2024-0201822

(51) Int. Cl. G09G 3/32

(52) U.S. Cl. CPC G09G 3/32; G09G 2300/0819; G09G 2300/0852; G09G 2300/0861; G09G 2310/0286; G09G 2310/08; G09G 2330/08; G09G 2330/10

(57) ABSTRACT

A light emitting diode display apparatus according to one or more examples includes a plurality of pixels having a plurality of sub-pixels. Each of the plurality of sub-pixels includes a light emitting part having a first light emitting device and a second light emitting device connected in series, a pixel circuit configured to control a current flowing through the light emitting part based on a data signal supplied through a data line and a pixel driving signal supplied through a gate line, and a current path circuit configured to select a current path flowing through the first light emitting device and the second light emitting device. Each of the plurality of pixels includes a selection circuit configured to control the current path circuit based on a selection signal and the pixel driving signal.

### CROSS-REFERENCE TO RELATED APPLICATION

This application claims the priority benefit of and priority to Korean Patent Application No. 10-2024-0201822 filed on Dec. 31, 2024, the entire contents of which are incorporated herein by reference for all purposes as if fully set forth herein.

### BACKGROUND

### 1. Technical Field

The present disclosure relates to an apparatus and particularly to, for example, without limitation, a light emitting diode display apparatus.

### 2. Description of the Related Art

Display apparatuses are being widely used as a display screen of notebook computers, tablet computers, smartphones, portable display devices, and portable information devices or the like in addition to a display screen of television (TVs) and monitors.

Liquid crystal display apparatuses and organic light emitting display apparatuses display an image by using thin-film transistors as switching elements. Since the liquid crystal display apparatuses cannot self-emit light, the liquid crystal display apparatuses display an image by using light emitted from a backlight unit which is disposed under a liquid crystal display panel. Since the liquid crystal display apparatuses include a backlight unit, a design of the liquid crystal display apparatuses is limited, and luminance and a response time are reduced. Since the organic light emitting display apparatuses include an organic material, the organic light emitting display apparatuses are vulnerable to water, causing a reduction in reliability and lifetime.

Recently, research and development on light emitting diode display apparatuses including a micro light emitting device are being done. The light emitting diode display apparatuses have high image quality and high reliability, and thus, are attracting much attention as next-generation display devices.

However, in a related art light emitting diode display apparatus, a screen defect occurs due to a defect of a micro light emitting diode device which occurs in a process of transferring a micro light emitting device onto a thin-film transistor array substrate.

The description of related art should not be considered prior art merely because it is mentioned in or associated with this section. The description of related art includes information that describes one or more aspects of the subject technology, and the description in this section does not limit the scope of the present disclosure.

### SUMMARY

One or more aspects of the present disclosure are directed to provide a light emitting diode display apparatus that substantially obviates one or more problems due to limitations and disadvantages of the related art.

One or more aspects of the present disclosure are directed to providing a light emitting diode display apparatus capable of minimizing or reducing light emission defects in a sub-pixel caused by a defect in a light emitting device.

One or more aspects of the present disclosure are directed to providing a light emitting diode display apparatus capable of minimizing or reducing light emission defects in a sub-pixel by arranging a plurality of light emitting devices within a sub-pixel.

One or more aspects of the present disclosure are directed to providing a light emitting diode display apparatus capable of allowing the remaining light emitting devices to emit light normally even if an open defect or a short circuit defect occurs in one of a plurality of light emitting devices connected in series.

Additional features, advantages, and aspects of the present disclosure are set forth in part in the present disclosure and will also be apparent from the present disclosure or may be learned by practice of the inventive concepts provided herein. Other features, advantages, and aspects of the present disclosure may be realized and attained by the descriptions provided in the present disclosure, or derivable therefrom, and claims hereof as well as the appended drawings.

To achieve these and other advantages and aspects of the present disclosure, as embodied and broadly described herein, in one or more aspects, a light emitting diode display apparatus comprises a plurality of pixels having a plurality of sub-pixels. Each of the plurality of sub-pixels comprises a light emitting part having a first light emitting device and a second light emitting device connected in series, a pixel circuit configured to control a current flowing through the light emitting part based on a data signal supplied through a data line and a pixel driving signal supplied through a gate line, and a current path circuit configured to select a current path flowing through the first light emitting device and the second light emitting device. Each of the plurality of pixels includes a selection circuit configured to control the current path circuit based on a selection signal and the pixel driving signal.

Details of other example embodiments will be included in the detailed description of the disclosure and the accompanying drawings.

According to one or more embodiments of the present disclosure, light emission defects in a sub-pixel caused by a defect in a light emitting device may be minimized.

According to one or more embodiments of the present disclosure, a plurality of light emitting devices are disposed in a sub-pixel, and thus, light emission defects in the sub-pixel may be minimized or reduced.

According to one or more embodiments of the present disclosure, even if an open defect or a short circuit defect occurs in one of a plurality of light emitting devices connected in series, the remaining light emitting devices may emit light normally.

Other systems, methods, features and advantages will be, or will become, apparent to one with skill in the art upon examination of the following features and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure and together with the description serve to explain principles of the disclosure. However, the technical features of the present embodiment are not limited to those shown in the specific drawings, and the features disclosed in each drawing may be combined to form a new embodiment.

FIG. 1 is a view illustrating a light emitting diode display apparatus according to an embodiment of the present disclosure.

FIG. 2 is an equivalent circuit diagram illustrating one sub-pixel illustrated in FIG. 1.

FIG. 3 is a circuit diagram illustrating a light emitting part and a pixel circuit illustrated in FIG. 2.

FIG. 4 is a circuit diagram illustrating a selection circuit according to an embodiment of the present disclosure illustrated in FIG. 2.

FIG. 5 is a cross-sectional view taken along line A-A′ illustrated in FIG. 2.

FIG. 6 is a diagram illustrating a driving timing of a selection circuit illustrated in FIG. 2.

FIGS. 7A and 7B are diagrams illustrating operations of the selection circuit based on a driving timing illustrated in FIG. 6.

FIG. 8 is a diagram illustrating a driving timing of one sub-pixel illustrated in FIG. 2.

FIGS. 9A to 9E are diagrams illustrating operations of the sub-pixel based on the driving timing illustrated in FIG. 8.

FIGS. 10A and 10B are diagrams illustrating current paths and light emission of a light emitting part in a light emitting diode display apparatus according to an embodiment of the present disclosure.

FIG. 11 is a diagram illustrating a plurality of sub-pixels in a light emitting diode display apparatus according to an embodiment of the present disclosure.

FIG. 12 is a diagram illustrating a driving timing for a plurality of sub-pixels illustrated in FIG. 11.

FIG. 13 is a diagram illustrating a unit pixel of a light emitting diode display apparatus according to another embodiment of the present disclosure.

FIG. 14 is a diagram illustrating a selection signal according to another embodiment of the present disclosure.

FIGS. 15A and 15B are diagrams illustrating current paths and light emission of a light emitting part configured in each of a plurality of sub-pixels in a light emitting diode display apparatus according to another embodiment of the present disclosure.

FIG. 16 is a diagram illustrating a selection circuit according to another embodiment of the present disclosure illustrated in FIG. 2.

FIG. 17 is a diagram illustrating a driving timing of the selection circuit illustrated in FIG. 16.

FIGS. 18A to 18C are diagrams illustrating operations of the selection circuit based on the driving timing illustrated in FIG. 17.

FIG. 19 is a diagram illustrating a driving timing of the selection circuit illustrated in FIG. 16.

FIGS. 20A to 20C are diagrams illustrating operations of the selection circuit based on the driving timing illustrated in FIG. 19.

FIG. 21 is a diagram illustrating a unit pixel of a light emitting diode display apparatus according to another embodiment of the present disclosure.

FIG. 22 is a diagram illustrating a selection signal according to another embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, electrodes, structures, transistors, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. Any references to singular may include plural, and vice versa, unless expressly stated otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, electrodes, structures, transistors, sections, members, parts, regions, areas, portions, and/or the like) are described using any of the terms such as “on,” “on a top of,” “upon,” “on top of,” “over,” “under,” “above,” “upper,” “below,” “lower,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “back,” “left,” “right,” “top,” “bottom,” “upper,” “lower,” “downward,” “upward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” “A,” “B,” “(a),” “(b),” “first-first,” “first-second,” “first-third,” “first-fourth,” “first-fifth,” “second-first,” “second-second,” “second-third,” “second-fourth,” “second-fifth,” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. Further, these are not used to define the essence or basis of the elements. These terms are merely used to refer to one element separately from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

The expression that an element (e.g., layer, film, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “covers,” “surrounds,” “is in contact,” “contacts,” “overlaps,” “crosses,” “intersects,” “is connected,” “is coupled,” “is attached,” “is adhered,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The phrase “through” may be understood, for example, to be at least partially through or entirely through.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally. For example, the terms “first direction,” “second direction,” “third direction,” “X-axis direction,” “Y-axis direction,” “Z-axis direction,” and the like should not be interpreted only based on a geometrical relationship in which the respective directions are parallel, perpendicular, diagonal, or slanted with respect to each other, and may be meant as directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) one or more elements of the plurality of elements, (v) multiple elements of the plurality of elements, or (vi) all of the plurality of elements. Moreover, “at least some,” “some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, (iii) the element, or (iv) all portions of the element.

The expression of a first element, a second elements “and/or” a third element should be understood as any one of the first, second and third elements or as any or all combinations of the first, second and third elements. Similar interpretations apply to the use of “and/or” with two elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise. In one or more aspects, unless stated otherwise, the term “nth” may refer to “nnd” (e.g., 2nd where n is 2), or “nrd” (e.g., 3rd where n is 3), and n may be a natural number or a whole number.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

Features of various embodiments of the present disclosure may be partially or entirely coupled to or combined with each other, may be technically associated with each other, and may be variously inter-operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein. For example, the term “part” or “unit” may apply to, for example, a circuit, a component, a device, an integrated circuit, a computational block of a circuit device, or a structure configured to perform a described function as should be understood by one of ordinary skill in the art.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same or similar elements may be illustrated in other drawings, and like reference numerals may refer to like or similar elements unless stated otherwise. The same or similar elements may be denoted by the same reference numerals even if they are depicted in different drawings. Repetitive descriptions of the same or similar elements may be omitted for brevity, and the descriptions provided for elements in one or more figures may also apply to elements in other figures that use the same or similar reference numerals unless stated otherwise. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

In description of flow of a signal, for example, when a signal is provided (e.g., transferred or transmitted) from a node A to a node B, this may include a case where the signal is provided from the node A to the node B via one or more nodes unless a phrase such as “immediately provided,” “directly provided” or the like is used. In one or more examples, a source (or a source electrode) may refer to a drain (or a drain electrode), and vice versa.

FIG. 1 is a view illustrating a light emitting diode display apparatus according to an embodiment of the present disclosure.

Referring to FIG. 1, the light emitting diode display apparatus according to an embodiment of the present disclosure may include a substrate 100 and a plurality of pixels. The plurality of pixels may include a plurality of sub-pixels SP.

The substrate 100 may be a first substrate, a thin-film transistor array substrate, or a pixel array substrate. The substrate 100 may be formed of glass or a plastic material. The substrate 100 according to an embodiment may include a display area AA and a non-display area IA.

The display area AA may be disposed in a center portion of the substrate 100 other than an edge portion of the substrate 100. The display area AA may be defined as a pixel array area including the plurality of sub-pixels SP that display an image.

The non-display area IA may be disposed in a remaining portion other than the display area AA disposed at the substrate 100 and may be defined as the edge portion of the substrate 100 surrounding the display area AA. The non-display area IA may be a peripheral portion outside the display area AA and cannot display an image unlike the display area AA, and moreover, the non-display area IA may be defined as an area where lines and circuits or the like for driving the plurality of sub-pixels SP are disposed.

The substrate 100 according to an embodiment may include a plurality of data lines DL, a plurality of gate lines GL, a plurality of pixel driving voltage lines PL, a plurality of selection signal lines SSL, and a plurality of sub-pixels SP.

The plurality of data lines DL may be disposed on the substrate 100, spaced apart at a certain interval along a first direction X (or X-axis direction) of the substrate 100, and may extend long along a second direction Y (or Y-axis direction) of the substrate 100. The plurality of data lines DL may be disposed in each of a plurality of sub-pixels SP. For example, each of the plurality of data lines DL may be shared by sub-pixels disposed along the second direction Y among the plurality of sub-pixels SP. Each of the plurality of data lines DL may be configured to supply (or transmit) a data signal provided from a panel driving circuit part to the plurality of sub-pixels SP. For example, the first direction X may be defined in a direction parallel to a long-side length direction of the substrate 100, and the second direction Y may be defined in a direction parallel to a short-side length direction of the substrate 100, but may be defined as a direction opposite thereto.

The plurality of gate lines GL may be disposed on the first substrate 100, may long extend along the first direction X (or X-axis direction) of the substrate 100 and may be spaced apart at a certain interval along the second direction Y (or Y-axis direction). Each of the plurality of gate lines GL may be shared by sub-pixels disposed along the first direction X among the plurality of sub-pixels SP. Each of the plurality of gate lines GL may be configured to supply (or transmit) a pixel driving signal provided from the panel driving circuit part to the plurality of sub-pixels SP.

The plurality of pixel driving voltage lines PL may be disposed on the substrate 100 in parallel with the plurality of data lines DL and may be formed together with each of the plurality of gate lines GL, but is not limited thereto. For example, the plurality of pixel driving voltage lines PL may also be disposed on the substrate 100 parallel to the data lines DL. Each of the plurality of pixel driving voltage lines PL may be configured to supply (or transmit) a pixel driving voltage (or a high-potential voltage) provided from the panel driving circuit part to the plurality of sub-pixels SP.

The plurality of selection signal lines SSL may be disposed on the substrate 100 in parallel with the data lines DL. The plurality of selection signal lines SSL may be disposed in each of the plurality of sub-pixels SP. For example, each of the plurality of selection signal lines SSL may be shared by sub-pixels disposed along the second direction Y among the plurality of sub-pixels SP. Each of the plurality of selection signal lines SSL may be configured to supply (or transmit) a selection signal provided from the panel driving circuit part to the plurality of sub-pixels SP.

Each of the plurality of sub-pixels SP may be disposed in a sub-pixel area defined by the gate lines GL and the data lines DL. Each of the plurality of sub-pixels SP may be defined as a minimum unit where light is actually emitted. Each of the plurality of sub-pixels SP may include a plurality of light emitting devices connected in series. Each of the plurality of sub-pixels SP may be configured to display an image based on light emission of one or more of the plurality of light emitting devices. Each of the plurality of sub-pixels SP may include a data line DL, a gate line GL, a pixel driving voltage line PL, and a selection signal line SSL.

Three or more adjacent sub-pixels SP among the plurality of sub-pixels SP may configure one unit pixel UP for color display. The one unit pixel UP may include an adjacent red sub-pixel, a green sub-pixel, and a blue sub-pixel, but is not limited thereto. For example, the one unit pixel UP may include one or more red sub-pixels, a plurality of green sub-pixels, and one or more blue sub-pixels.

The substrate 100 according to an embodiment may further include a plurality of reference voltage lines RL. The plurality of reference voltage lines RL may be disposed on the substrate 100 to be parallel to the data lines DL. Each of the plurality of reference voltage lines RL may be disposed to be shared by one or more sub-pixels SP. For example, each of the plurality of reference voltage lines RL may be configured to supply (or transmit) a reference voltage provided from the panel driving circuit part to the plurality of sub-pixels SP.

The light emitting diode display apparatus according to an embodiment of the present disclosure may further include an opposing substrate 500.

The opposing substrate 500 may be disposed to cover the substrate 100. The opposing substrate 500 may be defined as a second substrate, a protective substrate, a counter substrate, or an encapsulation substrate. The opposing substrate 500 may be opposite-bonded to the substrate 100 by a transparent adhesive member. The substrate 100 and the opposing substrate 500 opposite-bonded to the substrate 100 may configure a display panel 10.

The light emitting diode display apparatus according to an embodiment of the present disclosure may further include a gate driving circuit 11 and the panel driving circuit part 900.

The gate driving circuit 11 may be configured to supply a pixel driving signal in a predetermined order to the plurality of gate lines GL based on a gate control signal supplied from the panel driving circuit part 30. For example, the pixel driving signal supplied to each of the plurality of gate lines GL may include a first scan signal, a second scan signal, and an emission control signal. For example, the emission control signal may include a duty-on period (or an emission period) and a duty-off period (or a non-emission period) based on a pulse width modulation scheme to reduce a power consumption of the display apparatus. For example, the duty-on period of the emission control signal may correspond to one horizontal period, and the duty-off period of the emission control signal may correspond to two horizontal periods, but is not limited thereto. For example, a ratio of the duty-on period to the duty-off period of the emission control signal may be varied based on a luminance and a power consumption or the like of the display apparatus.

The gate driving circuit 11 according to an embodiment may be formed (or configured) in the non-display area IA of the substrate 100. For example, the gate driving circuit 11 may include a first gate driving circuit 11A and a second gate driving circuit 11B.

The first gate driving circuit 11A may be disposed in a first non-display area (or a left non-display area) of the display area AA to be electrically connected to one end of each of the plurality of gate lines GL. The second gate driving circuit 11B may be disposed in a second non-display area (or a right non-display area) to be electrically connected to the other end of each of the plurality of gate lines GL. The gate driving circuit 11 (or the first and second gate driving circuits 11A and 11B) may be directly formed or implemented in the non-display area IA of the substrate 100 through a manufacturing process of the thin-film transistors of the sub-pixels SP based on the GIP (gate in panel) scheme. For example, the gate driving circuit 11 (or the first and second gate driving circuits 11A and 11B) may be a gate integrated circuit or a gate shift register circuit, but is not limited thereto.

The gate driving circuit 11 according to another embodiment may be formed (or configured) in the display area AA of the substrate 100. For example, the gate driving circuit 11 may be directly formed or implemented in the display area AA of the substrate 100 based on the GIA (gate in active area) scheme. For example, the gate driving circuit 11 may include a shift register circuit including a plurality of stages composed of a plurality of transistors. Each of the plurality of transistors configuring each of the plurality of stages may be directly formed or implemented in the display area AA of the substrate 100 through the manufacturing process of the thin-film transistors of the sub-pixels SP. For example, each of the plurality of transistors configuring each of the plurality of stages may be distributed and disposed in an area between the plurality of sub-pixels SP within the display area AA.

The panel driving circuit part 30 may be connected to a pad part 12 provided in the non-display area of one side of the substrate 100, and may be configured to display an image corresponding to image data supplied from a display driving system (or a host controller) in the display area AA.

The panel driving circuit part 30 according to an embodiment may include a plurality of flexible circuit films 31, a plurality of data driving integrated circuits 33, a printed circuit board 35, a timing controller 37, and a power circuit 39.

Each of the plurality of flexible circuit films 31 may be attached to the pad part 12 of the substrate 100 by a film attachment process.

Each of the plurality of data driving integrated circuits 33 may be individually mounted on each of the plurality of flexible circuit films 31. The data driving integrated circuit 33 may receive sub-pixel data and data control signals provided from the timing controller 37, and may convert the sub-pixel data into analog sub-pixel data signals (or voltages) for each sub-pixel based on the data control signals and supply the analog sub-pixel data signals to corresponding data lines DL.

The printed circuit board 35 may be connected to the plurality of flexible circuit films 31. The printed circuit board 35 may support the timing controller 37 and the power circuit 39 and may serve to transmit signals and power between the components of the panel driving circuit part 30.

The timing controller 37 may be mounted on the printed circuit board 35 and receive image data and timing synchronization signals provided from the display driving system through a user connector provided on the printed circuit board 35. The timing controller 37 may generate sub-pixel data by aligning the image data to suit an arrangement structure of the sub-pixels SP in the display area AA based on the timing synchronization signals and provide the generated sub-pixel data to the data driving integrated circuit 33.

The timing controller 37 may be configured to generate data control signals and gate control signals based on the timing synchronization signals to control the driving timing of each of the plurality of data driving integrated circuits 33 and the gate driving circuit 11.

The timing controller 37 may be configured to generate a selection signal based on a location information of abnormal sub-pixels (or repair sub-pixel information) and supply the generated selection signal to the plurality of selection signal lines. For example, the location information of the abnormal sub-pixels may be obtained by an open defect inspection or a short circuit defect inspection for a plurality of light emitting devices which are transferred (or disposed) in each of the plurality of sub-pixels SP. The location information of the abnormal sub-pixels may be stored in a separate memory or in an internal memory of the timing controller 37. Accordingly, the timing controller 37 may be configured to generate and output the selection signal at a driving timing of the sub-pixels corresponding to the location information of the abnormal sub-pixels stored in the memory. For example, the timing controller 37 may be configured to generate the selection signal so that, even if an open defect (or a short circuit defect) occurs in one light emitting device of the plurality of light emitting devices which are connected in series at each of the plurality of sub-pixels SP, the remaining light emitting devices emit normally.

The power circuit 39 may be mounted on the printed circuit board 35 and may generate various voltages necessary for displaying an image in the display area AA using an input power supplied from an outside and supply the voltages to corresponding elements.

The panel driving circuit part 30 may further include a control board connected to the printed circuit board 35. For example, the timing controller 37 and the power circuit 39 are not mounted on the printed circuit board 35, but may be mounted on the control board. Accordingly, the printed circuit board 35 may serve only to transmit signals and power between the plurality of flexible circuit films 31 and the control board.

According to another embodiment of the present disclosure, the pad part 12 disposed at the non-display area IA of one side of the substrate 100 may be formed (or configured) on a rear surface of the substrate 100. For example, the pad part 12 may include a plurality of pad electrodes. Each of the plurality of pad electrodes formed at the rear surface of the substrate 100 may be individually connected to the plurality of signal lines disposed in the display area AA through side routing lines which are formed at a side surface of the substrate 100. Since the pad part 12 is disposed at the rear surface of the substrate 100, a width of the non-display area IA of the substrate 100 may be minimized or reduced. Furthermore, it may be possible to implement a zero bezel in which there is no non-display area IA of the substrate 100.

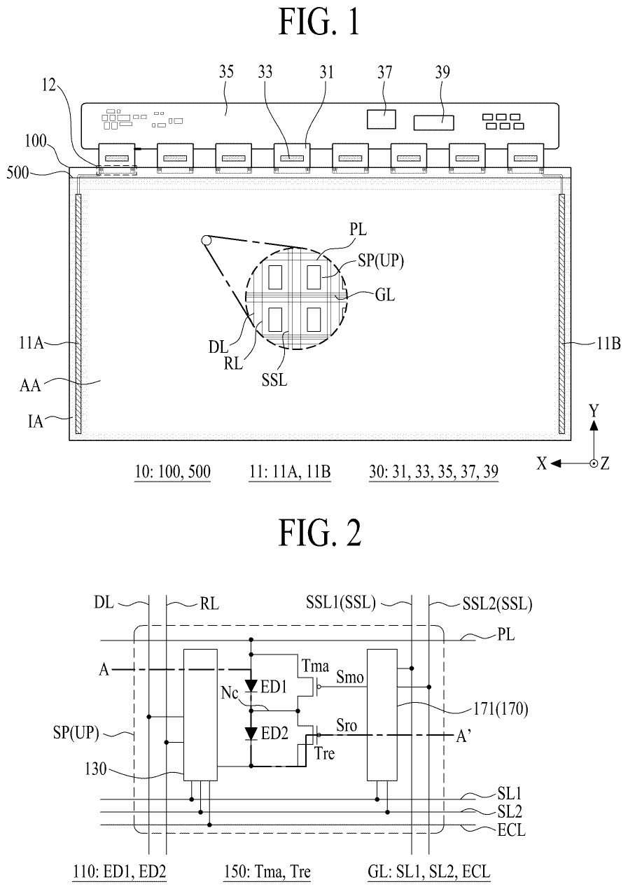

FIG. 2 is an equivalent circuit diagram illustrating one sub-pixel illustrated in FIG. 1.

Referring to FIGS. 1 and 2, each of the plurality of sub-pixels SP according to an embodiment of the present disclosure may be disposed (or configured) in a sub-pixel area defined by the data lines DL and the gate lines GL. Each of the plurality of sub-pixels SP may be configured to be connected to a data line DL, a gate line GL, a pixel driving voltage line PL, a reference voltage line RL, and a selection signal line SSL.

Each of the plurality of sub-pixels SP according to an embodiment of the present disclosure may include a light emitting part 110, a pixel circuit 130, a current path circuit 150, and a selection circuit 170.

The light emitting part 110 may include a plurality of light emitting devices ED1 and ED2 which are connected in series. For example, each of the plurality of light emitting devices ED1 and ED2 may be a micro light emitting device, a micro light emitting diode, or a micro light emitting diode chip. For example, each of the plurality of light emitting devices ED1 and ED2 may have a scale of 1 μm to 100 μm, but is not limited thereto.

The light emitting part 110 according to an embodiment may include a first light emitting device ED1 and a second light emitting device ED2 which are connected in series.

The first light emitting device ED1 may be electrically connected between the pixel driving voltage line PL and a common node Nc. For example, a first electrode (or an anode electrode) of the first light emitting device ED1 may be electrically connected to the pixel driving voltage line PL, and a second electrode (or a cathode electrode) of the first light emitting device ED1 may be electrically connected to the common node Nc.

The second light emitting device ED2 may be electrically connected in series with the first light emitting device ED1. The second light emitting device ED2 may be electrically connected between the common node Nc and the pixel circuit 130. For example, a first electrode (or an anode electrode) of the second light emitting device ED2 may be electrically connected to the second electrode of the first light emitting device ED1 through the common node Nc, and a second electrode (or a cathode electrode) of the second light emitting device ED2 may be electrically connected to the pixel circuit 130.

Any one of the first light emitting device ED1 and the second light emitting device ED2 may be used as a redundancy light emitting device to prevent or reduce an operation failure due to a misalignment or an electrical impact occurring in a process of being mounted (or transferred) on the substrate 100. For example, the first light emitting device ED1 may be a main light emitting device, and the second light emitting device ED2 may be a redundancy light emitting device, or vice versa.

The pixel circuit 130 may be configured to control the current flowing to the light emitting part 110 based on the data signal supplied through the data lines DL and the pixel driving signal supplied through the gate lines GL.

The gate lines GL according to an embodiment may include a first scan line SL1, a second scan line SL2, and an emission control line ECL, but are not limited thereto.

The first scan line SL1 may be configured to supply a first scan signal provided from the gate driving circuit 11 to the pixel circuit 130 and the selection circuit 170. The second scan line SL2 may be configured to supply a second scan signal provided from the gate driving circuit 11 to the pixel circuit 130 and the selection circuit 170. The emission control line ECL may be configured to supply an emission control signal provided from the gate driving circuit 11 to the pixel circuit 130 and the selection circuit 170.

The current path circuit 150 may be a current path control circuit, a current bypass circuit, or a repair circuit, but is not limited thereto.

The current path circuit 150 may be configured to bypass the current flowing through the light emitting part 110. The current path circuit 150 may be configured to select a current path flowing through the first light emitting device ED1 and the second light emitting device ED2. For example, the current path circuit 150 may be configured to form a current path flowing through to a normal light emitting device bypassing a light emitting device having an open defect (or a short circuit defect) among the first and second light emitting devices ED1 and ED2 which are configured in the light emitting part 110. For example, the current flowing through the light emitting part 110 may flow through both the first light emitting device ED1 and the second light emitting device ED2, or may flow through any one of the first light emitting device ED1 and the second light emitting device ED2 and the current path circuit 150.

The current path circuit 150 according to an embodiment may include a first pass control transistor Tma and a second pass control transistor Tre.

The first pass control transistor Tma and the second pass control transistor Tre may be configured as a same or different thin-film transistors among P-type and N-type thin-film transistors. One or more of the first pass control transistor Tma and the second pass control transistor Tre may include a same or different semiconductor layers among an amorphous silicon, a polycrystalline silicon, a low-temperature polycrystalline silicon, an oxide, and an organic material. In the following description, the first and second pass control transistors Tma and Tre are described as the P-type thin-film transistor.

The first pass control transistor Tma may be configured to bypass a current applied to the first light emitting device ED1 when the first light emitting device ED1 fails to emit. For example, the first pass control transistor Tma may be configured to bypass the current applied to the first light emitting device ED1 when an open defect or a short circuit defect occurs in the first light emitting device ED1.

The first pass control transistor Tma may be electrically connected in parallel with the first light emitting device ED1. The first pass control transistor Tma may be connected to both ends of the first light emitting device ED1 and may be turned-on based on a first pass control signal Smo supplied from the selection circuit 170. For example, the first pass control transistor Tma may include a gate electrode receiving the first pass control signal Smo from the selection circuit 170, a source electrode (or a drain electrode) connected to the pixel driving voltage line PL and the first electrode of the first light emitting device ED1, and a drain electrode (or a source electrode) connected to the second electrode of the first light emitting device ED1 (or the common node Nc).

The second pass control transistor Tre may be configured to bypass a current applied to the second light emitting device ED2 when the second light emitting device ED2 fails to emit. For example, the second pass control transistor Tre may be configured to bypass the current applied to the second light emitting device ED2 when an open defect or a short circuit defect occurs in the second light emitting device ED2. For example, the second pass control transistor Tre may be configured to bypass the current applied to the second light emitting device ED2 through the first light emitting device ED1 or the first pass control transistor Tma and flow to the pixel circuit 130 when an open defect or a short circuit defect occurs in the second light emitting device ED2.

The second pass control transistor Tre may be electrically connected in parallel with the second light emitting device ED2 and may be electrically connected in series with the second pass control transistor Tre. The second pass control transistor Tre may be connected to both ends of the second light emitting device ED2 and may be turned-on based on a second pass control signal Sro supplied from the selection circuit 170. For example, the second pass control transistor Tre may include a gate electrode receiving the second pass control signal Sro from the selection circuit 170, a source electrode (or a drain electrode) connected to the second electrode of the first light emitting device ED1 (or the common node Nc) and the drain electrode of the first pass control transistor Tma, and a drain electrode (or a source electrode) connected to the second electrode of the second light emitting device ED2 (or the pixel circuit 130).

According to an embodiment, the current flowing through the light emitting part 110 may flow to the pixel circuit 130 through both the first light emitting device ED1 and the second light emitting device ED2. According to another embodiment, the current flowing through the light emitting part 110 may flow to the pixel circuit 130 through any one of the first light emitting device ED1 and the second light emitting device ED2 and any one of the first pass control transistor Tma and the second pass control transistor Tre.

The selection circuit 170 may be configured to control the current path circuit 150 based on a selection signal and a pixel driving signal. The selection circuit 170 may be configured to be connected to the selection signal line SSL, the first scan line SL1, the second scan line SL2, and the current path circuit 150.

The selection circuit 170 may be configured in each of the plurality of sub-pixels SP and may include a plurality of sub-selection circuits 171 connected to the first pass control transistor Tma and the second pass control transistor Tre of the current path circuit 150 which is configured in a corresponding sub-pixel among the plurality of sub-pixels SP. For example, each of the plurality of sub-pixels SP may be configured to include the light emitting part 110, the pixel circuit 130, the current path circuit 150, and the sub-selection circuit 171.

Each of the selection circuit 170 or the plurality of sub-selection circuits 171 may be configured to output the first pass control signal Smo and the second pass control signal Sro based on the selection signal supplied from the selection signal line SSL, the first scan signal supplied from the first scan line SL1, and the second scan signal supplied from the second scan line SL2. For example, the selection signal line SSL may include a first selection signal line SSL1 and a second selection signal line SSL2. Each of the selection circuit 170 or the plurality of sub-selection circuits 171 may be configured to output the first pass control signal Smo and the second pass control signal Sro based on the first and second selection signals supplied from the first and second selection signal lines SSL1 and SSL2, the first scan signal supplied from the first scan line SL1, and the second scan signal supplied from the second scan line SL2.

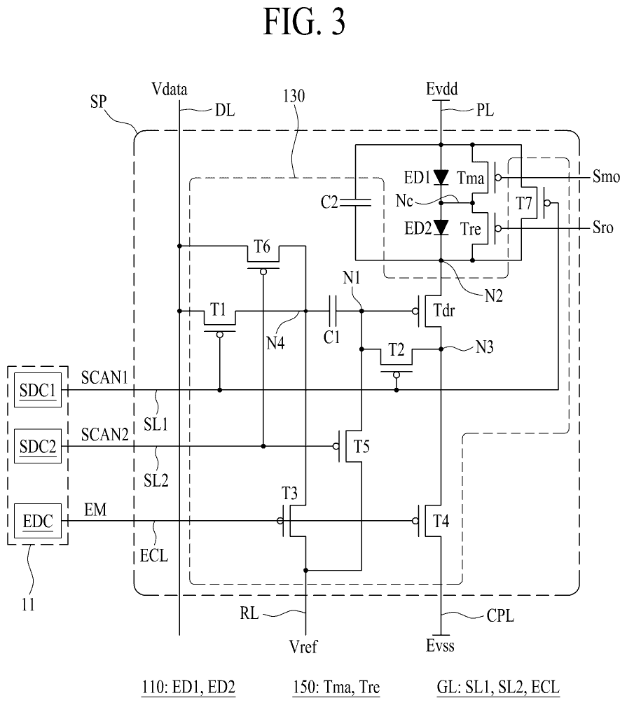

FIG. 3 is a circuit diagram illustrating a light emitting part and a pixel circuit illustrated in FIG. 2.

Referring to FIGS. 2 and 3, the pixel circuit 130 according to an embodiment of the present disclosure may include first to fourth nodes N1, N2, N3, and N4, a driving transistor Tdr, first to seventh transistors T1 to T7, a first capacitor C1, and a second capacitor C2.

The driving transistor Tdr and the first to seventh transistors T1 to T7 may be configured as a same or different thin-film transistors among P-type and N-type thin-film transistors. One or more of the driving transistor Tdr and the first to seventh transistors T1 to T7 may include a semiconductor layer made of a same or different materials among an amorphous silicon, a polycrystalline silicon, a low-temperature polycrystalline silicon, an oxide, and an organic material. In the following description, the driving transistor Tdr and the first to seventh transistors T1 to T7 are described as the P-type thin-film transistor.

The driving transistor Tdr may be connected to the first to third nodes N1, N2, and N3, and may be configured to control a current flowing to the third node N3 through the light emitting part 110 and the second node N2 based on a voltage of the first node N1. For example, the driving transistor Tdr may include a gate electrode connected to the first node N1, a source electrode connected to the second node N2, and a drain electrode connected to the third node N3. The source electrode of the driving transistor Tdr may be commonly connected to the light emitting part 110 and the current path circuit 150 through the second node N2.

The driving transistor Tdr may control the current flowing through the first light emitting device ED1 and the second light emitting device ED2 of the light emitting part 110 based on the voltage of the first node N1. The driving transistor Tdr may control the current flowing through any one of the first light emitting device ED1 and the second light emitting device ED2 and any one of the first pass control transistor Tma and the second pass control transistor Tre based on the voltage of the first node N1.

The first transistor T1 may be turned-on based on the first scan signal SCAN1 and may be connected between the data line DL and the fourth node N4. The first transistor T1 may supply (or transfer) a voltage (or a signal) supplied through the data line DL to the fourth node N4 based on the first scan signal SCAN1. For example, the first transistor T1 may include a gate electrode connected to the first scan line SL1, a source electrode (or a drain electrode) connected to the data line DL, and a drain electrode (or a source electrode) connected to the fourth node N4. For example, the first scan signal SCAN1 may be supplied to the first scan line SL1 from a first scan driving circuit SDC1 of the gate driving circuit 11. The first scan driving circuit SDC1 may be a shift register circuit including a plurality of stages configured to output the first scan signal SCAN1 in a predetermined order.

The second transistor T2 may be turned-on based on the first scan signal SCAN1 and may be connected between the first node N1 and the third node N3. The second transistor T2 may electrically connect the first node N1 and the third node N3 based on the first scan signal SCAN1 to connect the driving transistor Tdr in a diode form. For example, the second transistor T2 may include a gate electrode connected to the first scan line SL1, a source electrode (or a drain electrode) connected to the first node N1, and a drain electrode (or a source electrode) connected to the third node N3.

The third transistor T3 may be turned-on based on the emission control signal EM and may be connected between the reference voltage line RL and the fourth node N4. The third transistor T3 may supply (or transfer) a reference voltage Vref supplied through the reference voltage line RL to the fourth node N4 based on the emission control signal EM. For example, the third transistor T3 may include a gate electrode connected to the emission control line ECL, a source electrode (or a drain electrode) connected to the fourth node N4, and a drain electrode (or a source electrode) connected to the reference voltage line RL. For example, the emission control signal EM may be supplied to the emission control line ECL from an emission driving circuit EDC of the gate driving circuit 11. The emission driving circuit EDC may be a shift register circuit including a plurality of stages configured to output the emission control signal EM in a predetermined order. For example, the emission driving circuit EDC may be configured to output the emission control signal EM having duty-on and duty-off periods in a predetermined order.

The fourth transistor T4 may be turned-on based on the emission control signal EM and may be connected between a pixel common voltage line CPL and the third node N3. The fourth transistor T4 may supply (or transfer) a pixel common voltage (or a low-potential voltage) Evss supplied through the pixel common voltage line CPL to the third node N3 based on the emission control signal EM. For example, the fourth transistor T4 may include a gate electrode connected to the emission control line ECL, a source electrode (or a drain electrode) connected to the third node N3, and a drain electrode (or a source electrode) connected to the pixel common voltage line CPL.

The fifth transistor T5 may be turned-on based on the second scan signal SCAN2 and may be connected between the reference voltage line RL and the first node N1. The fifth transistor T5 may supply (or transfer) the reference voltage Vref supplied through the reference voltage line RL to the first node N1 based on the second scan signal SCAN2. For example, the fifth transistor T5 may include a gate electrode connected to the second scan line SL2, a source electrode (or a drain electrode) connected to the first node N1, and a drain electrode (or a source electrode) connected to the reference voltage line RL. For example, the second scan signal SCAN2 may be supplied to the second scan line SL2 from a second scan driving circuit SDC2 of the gate driving circuit 11. The second scan driving circuit SDC2 may be a shift register circuit including a plurality of stages configured to output the second scan signal SCAN2 in a predetermined order.

The sixth transistor T6 may be turned-on based on the second scan signal SCAN2 and may be connected between the data line DL and the fourth node N4. The sixth transistor T6 may supply (or transfer) a data voltage (or data signal) supplied through the data line DL to the fourth node N4 based on the second scan signal SCAN2. For example, the sixth transistor T6 may include a gate electrode connected to the second scan line SL2, a source electrode (or a drain electrode) connected to the data line DL, and a drain electrode (or a source electrode) connected to the fourth node N4.

The seventh transistor T7 may be turned-on based on the first scan signal SCAN1 and may be connected between the pixel driving voltage line PL and the second node N2. The seventh transistor T7 may be connected in parallel with the light emitting part 110 and may be connected in parallel with the current path circuit 150. The seventh transistor T7 may supply (or transfer) the pixel driving voltage Evdd supplied through the pixel driving voltage line PL to the second node N2 based on the first scan signal SCAN1. For example, the seventh transistor T7 may include a gate electrode connected to the first scan line SL1, a source electrode (or a drain electrode) connected to the pixel driving voltage line PL, and a drain electrode (or a source electrode) connected to the second node N2. For example, the seventh transistor T7 may prevent or reduce light emission of the light emitting part 110 in non-emission periods of the light emitting part 110 by bypassing the current flowing through the light emitting part 110 in the non-emission periods of the light emitting part 110.

The first capacitor C1 may be configured to be connected between the first node N1 and the fourth node N4. The first capacitor C1 may store a differential voltage between the voltage of the first node N1 and the voltage of the fourth node N4. For example, the first capacitor C1 may fix the voltage applied to the gate electrode of the driving transistor Tdr during an emission period of the light emitting part 110, thereby maintaining a constant current flowing through the driving transistor Tdr. For example, the first capacitor C1 may be a storage capacitor.

The second capacitor C2 may be configured to be connected between the pixel driving voltage line PL and the second node N2. The second capacitor C2 may be connected between the source electrode of the driving transistor Tdr and the pixel driving voltage line PL. The second capacitor C2 may be electrically connected in parallel with the light emitting part 110. The second capacitor C2 may constantly maintain an emission luminance of the light emitting part 110 by maintaining the voltages across both ends of the light emitting part 110. For example, the second capacitor C2 may prevent or minimize switching noise generated at a transition time of the first scan signal SCAN1 applied to the seventh transistor T7. The second capacitor C2 may have a same or different capacitance as the first capacitor C1. For example, the second capacitor C2 may have a smaller size than the first capacitor C1.

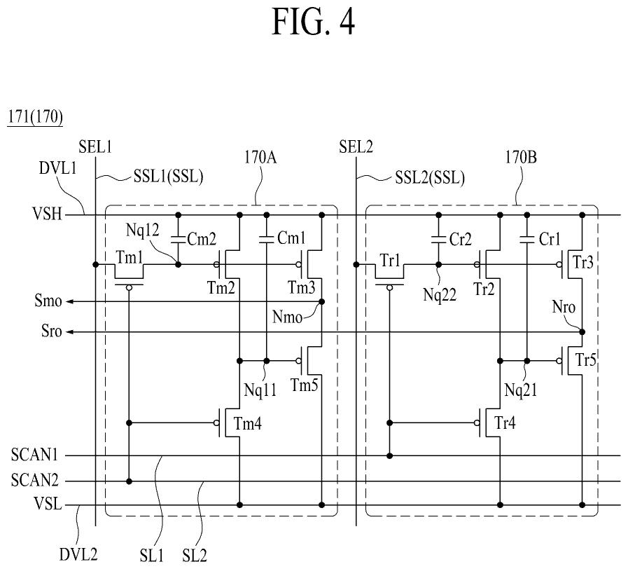

FIG. 4 is a circuit diagram illustrating a selection circuit according to an embodiment of the present disclosure illustrated in FIG. 2.

Referring to FIG. 4, the selection circuit 170 (or the sub-selection circuit 171) according to an embodiment of the present disclosure may include a first selection circuit 170A and a second selection circuit 170B.

The first selection circuit 170A may be configured to output the first pass control signal Smo based on a first selection signal SEL1 supplied through a first selection signal line SSL1 of the selection signal line SSL and a second scan signal SCAN2 supplied through the second scan line SL2.

The first selection circuit 170A according to an embodiment may include a first-first control node Nq11, a first-second control node Nq12, a first output node Nmo, first-first to first-fifth switching transistors Tm1 to Tm5, a first-first capacitor Cm1, and a first-second capacitor Cm2.

The first-first to first-fifth switching transistors Tm1 to Tm5 may be configured as a same or different thin-film transistors among P-type and N-type thin-film transistor. One or more of the first-first to first-fifth switching transistors Tm1 to Tm5 may include a same or different semiconductor layers among an amorphous silicon, a polycrystalline silicon, a low-temperature polycrystalline silicon, an oxide, and an organic material. In the following description, the first-first to first-fifth switching transistors Tm1 to Tm5 are described as the P-type thin-film transistor.

The first-first switching transistor Tm1 may be turned-on based on the second scan signal SCAN2 and may be connected between the first selection signal line SSL1 and the first-second control node Nq12. The first-first switching transistor Tm1 may supply the first selection signal SEL1 supplied through the first selection signal line SSL1 to the first-second control node Nq12 based on the second scan signal SCAN2. For example, the first-first switching transistor Tm1 may include a gate electrode connected to the second scan line SL2, a source electrode (or a drain electrode) connected to the first selection signal line SSL1, and a drain electrode (or a source electrode) connected to the first-second control node Nq12.

The first-second switching transistor Tm2 may be turned-on based on the voltage of the first-second control node Nq12 and may be connected between the first driving voltage line DVL1 and the first-first control node Nq11. The first-second switching transistor Tm2 may supply the first driving voltage VSH supplied through the first driving voltage line DVL1 to the first-first control node Nq11 based on the voltage of the first-second control node Nq12. For example, the first-second switching transistor Tm2 may include a gate electrode connected to the first-second control node Nq12, a source electrode (or a drain electrode) connected to the first driving voltage line DVL1, and a drain electrode (or a source electrode) connected to the first-first control node Nq11. For example, the first driving voltage VSH may have a voltage level capable of turning off the first-first to first-fifth switching transistors Tm1 to Tm5. For example, the first driving voltage VSH may be a high-potential voltage or a high logic voltage.

The first-third switching transistor Tm3 may be turned-on based on the voltage of the first-second control node Nq12 and may be connected between the first driving voltage line DVL1 and the first output node Nmo. The first-third switching transistor Tm3 may supply the first driving voltage VSH supplied through the first driving voltage line DVL1 to the first output node Nmo based on the voltage of the first-second control node Nq12. For example, the first-third switching transistor Tm3 may include a gate electrode connected to the first-second control node Nq12, a source electrode (or a drain electrode) connected to the first driving voltage line DVL1, and a drain electrode (or a source electrode) connected to the first output node Nmo.

The first-fourth switching transistor Tm4 may be turned-on based on the second scan signal SCAN2 and may be connected between a second driving voltage line DVL2 and the first-first control node Nq11. The first-fourth switching transistor Tm4 may supply the second driving voltage VSL supplied through the second driving voltage line DVL2 to the first-first control node Nq11 based on the second scan signal SCAN2. For example, the first-fourth switching transistor Tm4 may include a gate electrode connected to the second scan line SL2, a source electrode (or a drain electrode) connected to the second driving voltage line DVL2, and a drain electrode (or a source electrode) connected to the first-first control node Nq11. For example, the second driving voltage VSL may have a voltage level capable of turning on the first-first to first-fifth switching transistors Tm1 to Tm5. For example, the second driving voltage VSL may be a low-potential voltage or a low logic voltage.

The first-fifth switching transistor Tm5 may be turned-on based on the voltage of the first-first control node Nq11 and may be connected between the second driving voltage VSL line and the first output node Nmo. The first-fifth switching transistor Tm5 may supply the second driving voltage VSL supplied through the second driving voltage line DVL2 to the first output node Nmo based on the voltage of the first-first control node Nq11. For example, the first-fifth switching transistor Tm5 may include a gate electrode connected to the first-first control node Nq11, a source electrode (or a drain electrode) connected to the second driving voltage line DVL2, and a drain electrode (or a source electrode) connected to the output node Nmo.

The first-first capacitor Cm1 may be connected between the first-first control node Nq11 and the first driving voltage line DVL1. The first-first capacitor Cm1 may store a differential voltage between the voltage of the first-first control node Nq11 and a voltage of the first driving voltage line DVL1. For example, the first-first capacitor Cm1 may maintain the voltage of the first-first control node Nq11 for one frame.

The first-second capacitor Cm2 may be connected between the first-second control node Nq12 and the first driving voltage line DVL1. The first-second capacitor Cm2 may store a differential voltage between the voltage of the first-second control node Nq12 and the voltage of the first driving voltage line DVL1. For example, the first-second capacitor Cm2 may maintain the voltage of the first-second control node Nq12 for one frame. The first-second capacitor Cm2 may be configured to have a same capacitance as the first-first capacitor Cm1, but is not limited thereto. For example, the first-second capacitor Cm2 and the first-first capacitor Cm1 may be configured to have a same or different capacitance as the second capacitor C2 in the pixel circuit 130.

The second selection circuit 170B may be configured to output a second pass control signal Sro based on the second selection signal SEL2 which is supplied through the second selection signal line SSL2 of the selection signal line SSL and the first scan signal SCAN1 supplied through the first scan line SL1.

The second selection circuit 170B according to an embodiment may include a second-first control node Nq21, a second-second control node Nq22, a second output node Nro, second-first to second-fifth switching transistors Tr1 to Tr5, a second-first capacitor Cr1, and a second-second capacitor Cr2.

The second-first to second-fifth switching transistors Tr1 to Tr5 may be configured as a same or different thin-film transistors among P-type and N-type thin-film transistor. One or more of the second-first to second-fifth switching transistors Tr1 to Tr5 may include a semiconductor layer made of a same or different materials among an amorphous silicon, a polycrystalline silicon, a low-temperature polycrystalline silicon, an oxide, or an organic materials. In the following description, the second-first to second-fifth switching transistors Tr1 to Tr5 are described as the P-type thin-film transistor.

The second-first switching transistor Tr1 may be turned-on based on the first scan signal SCAN1 and may be connected between the second selection signal line SSL2 and the second-second control node Nq22. The second-first switching transistor Tr1 may supply the second selection signal SEL2 supplied through the second selection signal line SSL2 to the second-second control node Nq22 based on the first scan signal SCAN1. For example, the second-first switching transistor Tr1 may include a gate electrode connected to the first scan line SL1, a source electrode (or a drain electrode) connected to the second selection signal line SSL2, and a drain electrode (or a source electrode) connected to the second-second control node Nq22.

The second-second switching transistor Tr2 may be turned-on based on a voltage of the second-second control node Nq22 and may be connected between the first driving voltage line DVL1 and the second-first control node Nq21. The second-second switching transistor Tr2 may supply the first driving voltage VSH supplied through the first driving voltage line DVL1 to the second-first control node Nq21 based on the voltage of the second-second control node Nq22. For example, the second-second switching transistor Tr2 may include a gate electrode connected to the second-second control node Nq22, a source electrode (or a drain electrode) connected to the first driving voltage line DVL1, and a drain electrode (or a source electrode) connected to the second-first control node Nq21.

The second-third switching transistor Tr3 may be turned-on based on the voltage of the second-second control node Nq22 and may be connected between the first driving voltage line DVL1 and the second output node Nro. The second-third switching transistor Tr3 may supply the first driving voltage VSH supplied through the first driving voltage line DVL1 to the second output node Nro based on the voltage of the second-second control node Nq22. For example, the second-third switching transistor Tr3 may include a gate electrode connected to the second-second control node Nq22, a source electrode (or a drain electrode) connected to the first driving voltage line DVL1, and a drain electrode (or a source electrode) connected to the second output node Nro.

The second-fourth switching transistor Tr4 may be turned-on based on the first scan signal SCAN1 and may be connected between the second driving voltage line DVL2 and the second-first control node Nq21. The second-fourth switching transistor Tr4 may supply the second driving voltage VSL supplied through the second driving voltage line DVL2 to the second-first control node Nq21 based on the first scan signal SCAN1. For example, the second-fourth switching transistor Tr4 may include a gate electrode connected to the second scan line SL2, a source electrode (or a drain electrode) connected to the second driving voltage line DVL2, and a drain electrode (or a source electrode) connected to the second-first control node Nq21.

The second-fifth switching transistor Tr5 may be turned-on based on a voltage of the second-first control node Nq21 and may be connected between the second driving voltage VSL line and the second output node Nro. The second-fifth switching transistor Tr5 may supply the second driving voltage VSL supplied through the second driving voltage line DVL2 to the second output node Nro based on the voltage of the second-first control node Nq21. For example, the second-fifth switching transistor Tr5 may include a gate electrode connected to the second-first control node Nq21, a source electrode (or a drain electrode) connected to the second driving voltage line DVL2, and a drain electrode (or a source electrode) connected to the second output node Nro.

The second-first capacitor Cr1 may be connected between the second-first control node Nq21 and the first driving voltage line DVL1. The second-first capacitor Cr1 may store a differential voltage between the voltage of the second-first control node Nq21 and the voltage of the first driving voltage line DVL1. For example, the second-first capacitor Cr1 may maintain the voltage of the second-first control node Nq21 for one frame.

The second-second capacitor Cr2 may be connected between the second-second control node Nq22 and the first driving voltage line DVL1. The second-second capacitor Cr2 may store a differential voltage between the voltage of the second-second control node Nq22 and the voltage of the first driving voltage line DVL1. For example, the second-second capacitor Cr2 may maintain the voltage of the second-second control node Nq22 for one frame. The second-second capacitor Cr2 may be configured to have a same capacitance as the second-first capacitor Cr1, but is not limited thereto. For example, each of the second-second capacitor Cr2 and the second-first capacitor Cr1 may be configured to have a same capacitance as the first-second capacitor Cm2 and the first-first capacitor Cm1.

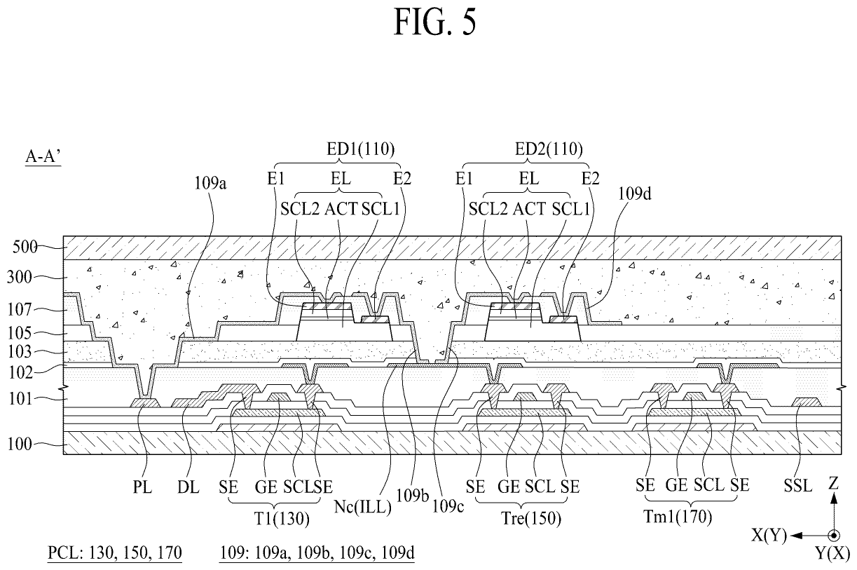

FIG. 5 is a cross-sectional view taken along line A-A′ illustrated in FIG. 2.

Referring to FIGS. 2 to 5, the light emitting diode display apparatus according to an embodiment of the present disclosure may include a pixel array layer PCL, a protective layer 101, an internal line layer ILL, an insulating layer 102, an adhesive layer 103, a light emitting part 110, first and second planarization layers 105 and 107, an electrode connection line 109, a cover layer 300, and an opposing substrate 500 which are disposed on a substrate 100.

The pixel array layer PCL may include pixel driving voltage line PL and data line DL, a pixel circuit 130, a current path circuit 150, and a selection circuit 170 which are disposed on the substrate 100. The pixel array layer PCL may be formed (or configured) together on the substrate 100 through a manufacturing process of thin-film transistors. For example, the data line DL and the selection signal line SSL may be formed (or configured) in a same layer with a same metal material as the source/drain of the thin-film transistor.

The protective layer 101 may be formed (or configured) to cover the pixel array layer PCL and to provide a flat surface over the pixel array layer PCL.

The internal line layer ILL may be disposed on the protective layer 101 and may be configured to include internal lines for electrical connections between the pixel circuit 130, the current path circuit 150, and the selection circuit 170.

The insulating layer 102 may be formed (or configured) on the protective layer 101 to cover the internal line layer ILL.

The adhesive layer 103 may be disposed on the insulating layer 102.

The light emitting part 110 may be disposed on an adhesive surface of the adhesive layer 103 and may be fixed by the adhesive layer 103.

Each of the first and second light emitting devices ED1 and ED2 of the light emitting part 110 may include a light emitting layer EL, a first electrode (or an anode terminal) E1, and a second electrode (or a cathode terminal) E2. For example, the first and second light emitting devices ED1 and ED2 may have a lateral structure, but are not limited thereto.

The light emitting layer EL may emit light according to the recombination of electrons and holes flowing between the first electrode E1 and the second electrode E2. The light emitting layer EL according to an embodiment may include a first semiconductor layer SCL1, an active layer ACT, and a second semiconductor layer SCL2.

The first semiconductor layer SCL1 may be configured to provide electrons to the active layer ACT. The first semiconductor layer SCL1 according to an embodiment may be made of an n-GaN-based semiconductor material. Examples of the n-GaN-based semiconductor material may include GaN, AlGaN, InGaN, or AlInGaN, or the like. For example, silicon (Si), germanium (Ge), selenium (Se), tellurium (Te), or carbon (C), or the like may be used as impurities used for doping of the first semiconductor layer SCL1.

The active layer ACT may be disposed on one side of the first semiconductor layer SCL1. The active layer ACT may have a multi-quantum well structure which includes a well layer and a barrier layer which is a higher bandgap than the well layer. For example, the active layer ACT may have a multi-quantum well structure of InGaN/GaN or the like.

The second semiconductor layer SCL2 may be disposed on the active layer ACT and may be configured to provide holes to the active layer ACT. The second semiconductor layer SCL2 according to an embodiment may be made of a p-GaN-based semiconductor material. Examples of the p-GaN-based semiconductor material may include GaN, AlGaN, InGaN, or AlInGaN, or the like. For example, magnesium (Mg), zinc (Zn), or beryllium (Be), or the like may be used as impurities used for doping of the second semiconductor layer SCL2.

The first electrode E1 may be disposed on the second semiconductor layer SCL2.

The second electrode E2 may be disposed on the other side of the first semiconductor layer SCL1 so as to be electrically disconnected (or separated) from the active layer ACT and the second semiconductor layer SCL2.

In FIG. 5, the first and second light emitting devices ED1 and ED2 are described as including a lateral structure, but are not limited thereto. For example, the first and second light emitting devices ED1 and ED2 may have a vertical structure or a flip-chip structure.

The first planarization layer 105 may be formed (or configured) on the adhesive layer 103 to surround side surfaces of the first and second light emitting devices ED1 and ED2. The positions of the first and second light emitting devices ED1 and ED2 may be further fixed by the first planarization layer 105.

The second planarization layer 107 may be formed (or configured) on the first planarization layer 105 to cover the first and second light emitting devices ED1 and ED2. In this way, the first and second light emitting devices ED1 and ED2 may be completely surrounded (or encapsulated) by the adhesive layer 103, the first planarization layer 105, and the second planarization layer 107.

The electrode connection line 109 may be disposed on the second planarization layer 107. The electrode connection line 109 may include first to fourth electrode connection lines 109a, 109b, 109c, and 109d.

The first electrode connection line 109a may be electrically connected between the first electrode E1 of the first light emitting device ED1 and the pixel driving voltage line PL. The second electrode connection line 109b may be electrically connected between the second electrode E2 of the first light emitting device ED1 and the common node Nc. The third electrode connection line 109c may be electrically connected between the first electrode E1 of the second light emitting device ED2 and the common node Nc. The fourth electrode connection line 109d may be electrically connected between the second electrode E2 of the second light emitting device ED2 and the source electrode (or the second node N2) of the driving transistor Tdr.

The cover layer 300 may be formed (or configured) to cover the light emitting part 110, the electrode connection line 109, and the second planarization layer 107. For example, the cover layer 300 may be a protective layer or a transparent optical adhesive layer.

The opposing substrate 500 may be disposed to cover the cover layer 300. The opposing substrate 500 may be attached to the cover layer 300.

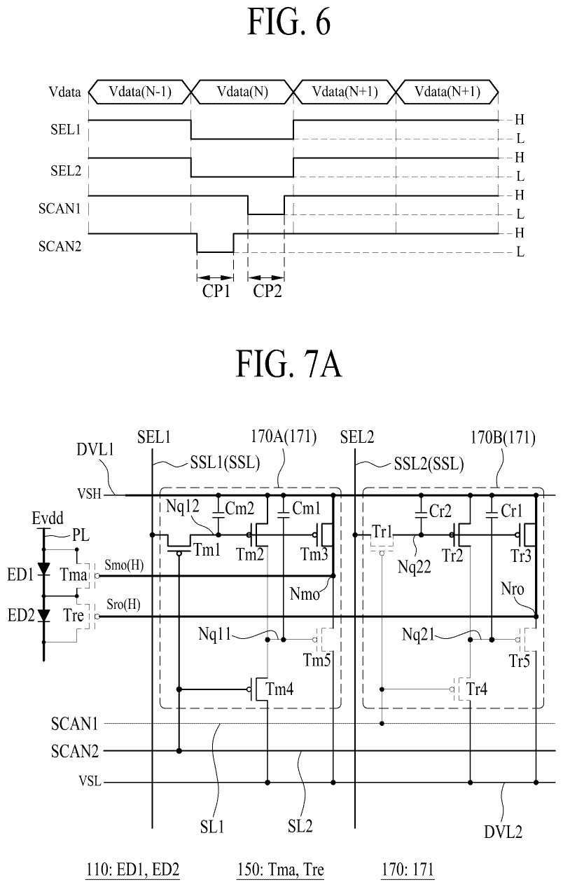

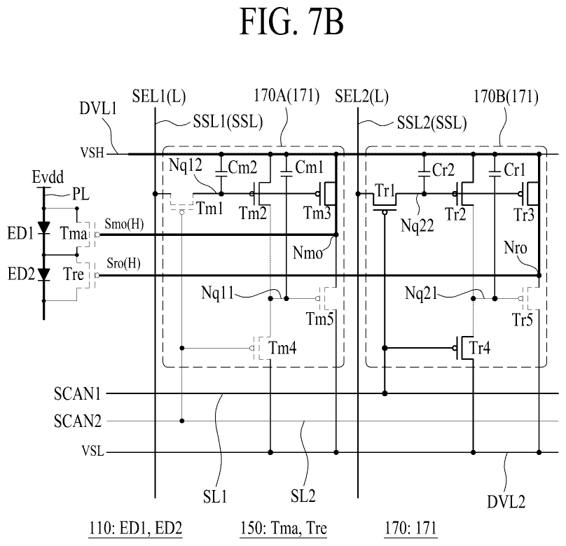

FIG. 6 is a diagram illustrating a driving timing of a selection circuit illustrated in FIG. 2. FIGS. 7A and 7B are diagrams illustrating operations of the selection circuit based on a driving timing illustrated in FIG. 6. FIGS. 6, 7A, and 7B illustrate operations of the selection circuit when both the first light emitting device and the second light emitting device illustrated in FIG. 2 are normally configured (or transferred).

Referring to FIGS. 6 and 7A, based on the normal driving of the first and second light emitting devices ED1 and ED2, each of the first and second selection signals SEL1 and SEL2 may have a low voltage level L synchronized with the first and second scan signals SCAN1 and SCAN2.

During a first current path formation period CP1 synchronized with a high voltage level H of the first scan signal SCAN1 and a low voltage level L of the second scan signal SCAN2, the selection circuit 170 (or the sub-selection circuit 171) may output a first pass control signal Smo of a high voltage level H and a second pass control signal Sro of a high voltage level H to the current path circuit 150, based on the first scan signal SCAN1 of the high voltage level H, the second scan signal SCAN2 of the low voltage level L, the first selection signal SEL1 of the low voltage level L, and the second selection signal SEL2 of the low voltage level L.

In the first selection circuit 170A during the first current path formation period CP1, the first-first and first-fourth switching transistors Tm1 and Tm4 are turned-on by the second scan signal SCAN2 of the low voltage level L, the first-second and first-third switching transistors Tm2 and Tm3 are turned-on by the first selection signal SEL1 of the low voltage level L which is applied to the first-second control node Nq12 through the first-first switching transistor Tm1, and the first-fifth switching transistor Tm5 is turned-off by the first driving voltage VSH of the high voltage level H which is applied to the first-first control node Nq11 through the first-second switching transistor Tm2. Accordingly, in the first selection circuit 170A, the first pass control signal Smo of the high voltage level H corresponding to the first driving voltage VSH which is supplied through the first driving voltage line DVL1 is supplied to the first pass control transistor Tma of the current path circuit 150 through the first-third switching transistor Tm3 and the first output node Nmo, and thus, the first pass control transistor Tma is turned-off.

In the second selection circuit 170B during the first current path formation period CP1, the second-first and second-fourth switching transistors Tr1 and Tr4 are turned-off by the first scan signal SCAN1 of the high voltage level H, the second-second and second-third switching transistors Tr2 and Tr3 maintain turned-on state by the voltage of the second-second control node Nq22 which is maintained at the low voltage level L by the second-second capacitor Cr2, and the second-fifth switching transistor Tr5 is turned-off by the first driving voltage VSH of the high voltage level H which is applied to the second-first control node Nq21 through the second-second switching transistor Tr2. Accordingly, in the second selection circuit 170B, the second pass control signal Sro of the high voltage level H corresponding to the first driving voltage VSH which is supplied through the first driving voltage line DVL1 is supplied to the second pass control transistor Tre of the current path circuit 150 through the second-third switching transistor Tr3 and the second output node Nro, and thus, the second pass control transistor Tre is turned-off.

Therefore, in the light emitting part 110 during the first current path formation period CP1, a current path flowing to the first light emitting device ED1 and the second light emitting device ED2 is formed as the first and second pass control transistors Tma and Tre are turned-off.

Referring to FIGS. 6 and 7B, during a second current path formation period CP2 synchronized with the first scan signal SCAN1 of the low voltage level L and the second scan signal SCAN2 of the high voltage level H, the selection circuit 170 (or sub-selection circuit 171) may output the first pass control signal Smo and the second pass control signal Sro of the high voltage level H to the current path circuit 150, based on the first scan signal SCAN1 of the low voltage level L, the second scan signal SCAN2 of the high voltage level H, the first selection signal SEL1 of the low voltage level L, and the second selection signal SEL2 of the low voltage level L.

In the first selection circuit 170A during the second current path formation period CP2, the first-first and first-fourth switching transistors Tm1 and Tm4 are turned-off by the second scan signal SCAN2 of the high voltage level H, the first-second and first-third switching transistors Tm2 and Tm3 maintain turned-on state by the voltage of the first-second control node Nq12 which is maintained at the low voltage level L by the first-second capacitor Cm2, and the first-fifth switching transistor Tm5 maintains turned-off state by the first driving voltage VSH of the high voltage level H which is applied to the first-first control node Nq11 through the first-second switching transistor Tm2. Accordingly, in the first selection circuit 170A, the first pass control signal Smo which is supplied to the first pass control transistor Tma of the current path circuit 150 may be maintained at the high voltage level H.

In the second selection circuit 170B during the second current path formation period CP2, the second-first and second-fourth switching transistors Tr1 and Tr4 are turned-on by the first scan signal SCAN1 of the low voltage level L, the second-second and second-third switching transistors Tr2 and Tr3 maintain turned-on state by the second selection signal SEL2 of the low voltage level L which is applied to the second-second control node Nq22 through the second-first switching transistor Tr1, and the second-fifth switching transistor Tr5 is remained in turned-off state by the first driving voltage VSH of the high voltage level H which is applied to the second-first control node Nq21 through the second-second switching transistor Tr2. Accordingly, in the second selection circuit 170B, the second pass control signal Sro which is supplied to the second pass control transistor Tre of the current path circuit 150 may be maintained at the high voltage level H.

Therefore, in the light emitting part 110 during the second current path formation period CP2, the current path flowing to the first light emitting device ED1 and the second light emitting device ED2 may be maintained as the first and second pass control transistors Tma and Tre are remained in turned-off state.

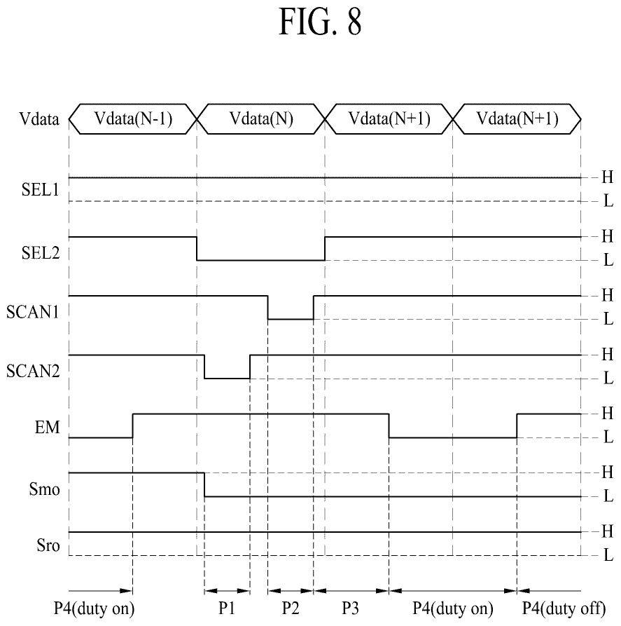

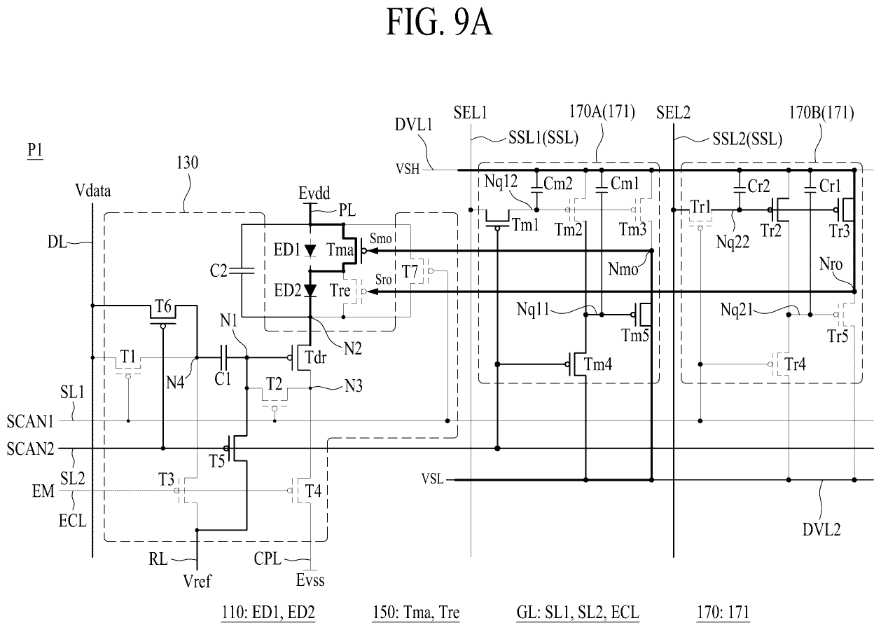

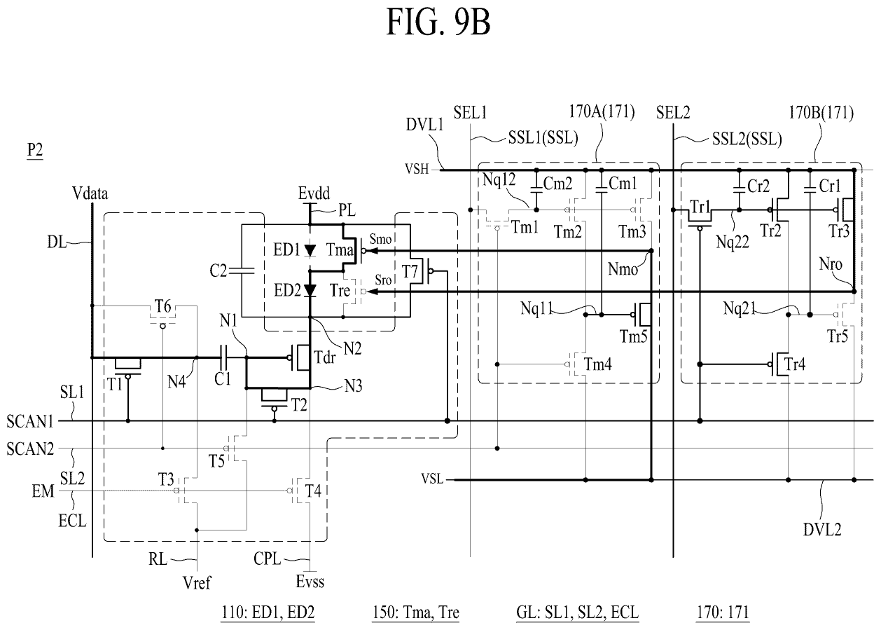

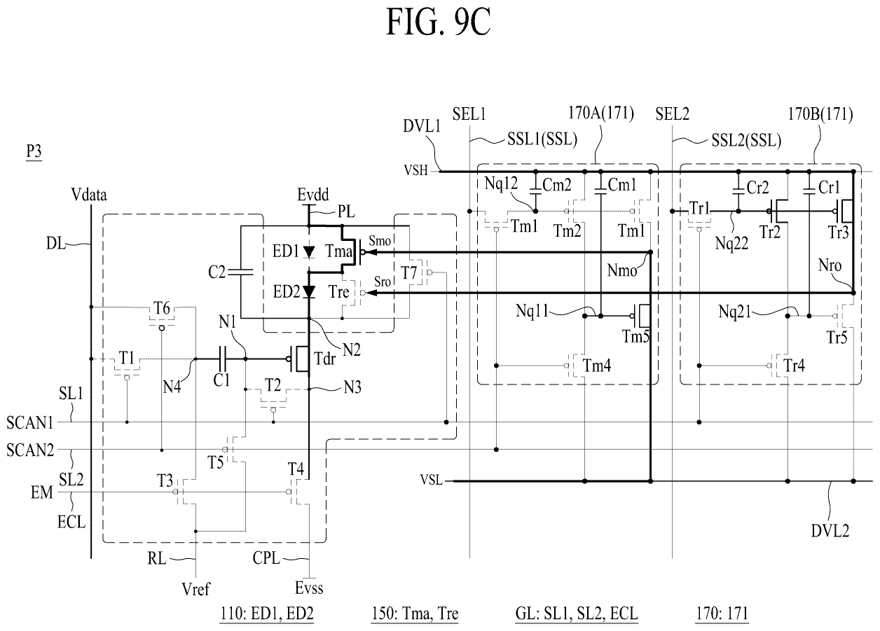

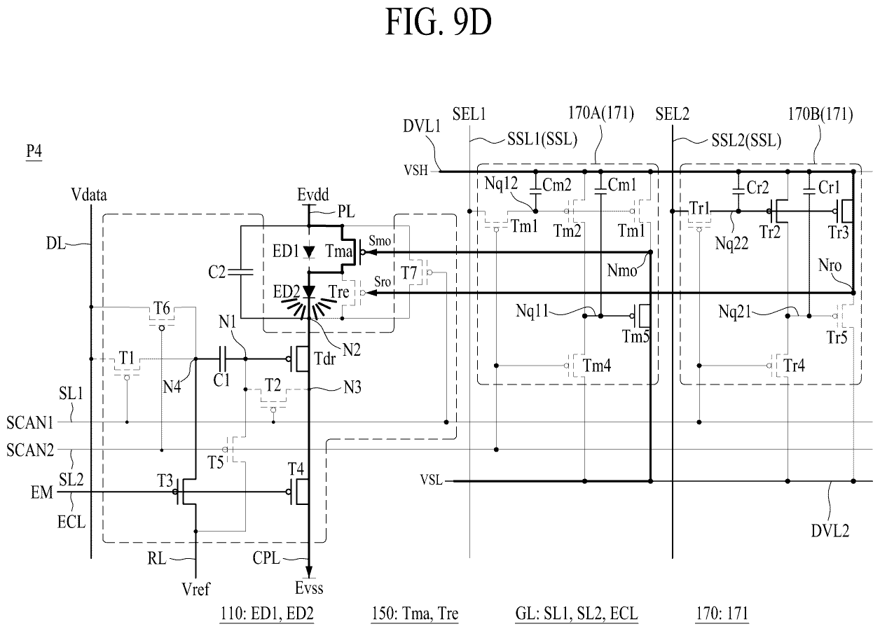

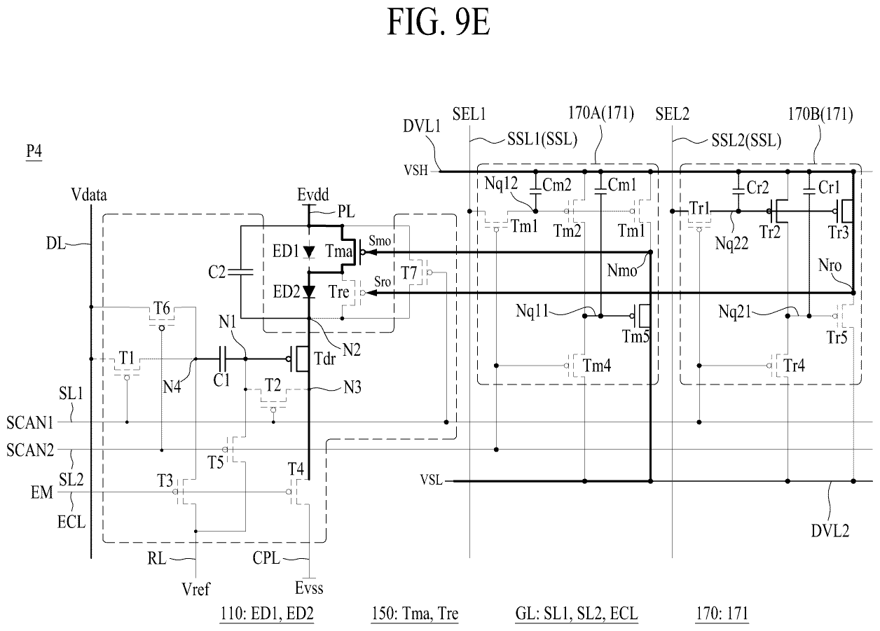

FIG. 8 is a diagram illustrating a driving timing of one sub-pixel illustrated in FIG. 2. FIGS. 9A to 9E are diagrams illustrating operations of the sub-pixel based on the driving timing illustrated in FIG. 8. FIGS. 8 and 9A to 9E illustrate operations of the sub-pixel depending on an open defect of the first light emitting device among the first light emitting device and the second light emitting device illustrated in FIG. 2.

Referring to FIGS. 8 and 9A to 9E, a driving method of a sub-pixel according to an embodiment of the present disclosure will be described as follows.

Referring to FIG. 8, the sub-pixel SP according to an embodiment of the present disclosure may include an initialization period P1, a sampling/data programming period P2, a holding period P3, and an emission modulation period P4. In addition, based on the open defect of the first light emitting device ED1, a first selection signal SEL1 may be maintained at a high voltage level H, and a second selection signal SEL2 may have a low voltage level L in a period synchronized with a second scan signal SCAN2.

Referring to FIGS. 8 and 9A, in the pixel circuit 130 during the initialization period P1, the first, second, and seventh transistors T1, T2, and T7 are turned-off based on the first scan signal SCAN1 of a high voltage level H, the third and fourth transistors T3 and T4 are turned-off based on the emission control signal EM of a high voltage level H, and the fifth and sixth transistors T5 and T6 are turned-on based on the second scan signal SCAN2 of a low voltage level L. Accordingly, a voltage of the first capacitor C1 may be initialized. For example, during the initialization period P1, an initialization data voltage Vdata which is applied to the data line DL is supplied to the fourth node N4 through the sixth transistor T6, and a reference voltage Vref which is applied to the reference voltage line RL is supplied to the first node N1 through the fifth transistor T5. Therefore, the first capacitor C1 may be initialized with a differential voltage between the initialization data voltage Vdata and the reference voltage Vref. For example, the initialization data voltage Vdata may have a same voltage level as the reference voltage Vref.

During the initialization period P1, the selection circuit 170 (or sub-selection circuit 171) may output a first pass control signal Smo of the low voltage level L and a second pass control signal Sro of the high voltage level H to the current path circuit 150, based on the first scan signal SCAN1 of the high voltage level H, the second scan signal SCAN2 of the low voltage level L, the first selection signal SEL1 of the high voltage level H, and the second selection signal SEL2 of the low voltage level L.

In the first selection circuit 170A during the initialization period P1, the first-first and first-fourth switching transistors Tm1 and Tm4 are turned-on by the second scan signal SCAN2 of the low voltage level L, the first-second and first-third switching transistors Tm2 and Tm3 are turned-off by the first selection signal SEL1 of the high voltage level H which is applied to the first-second control node Nq12 through the first-first switching transistor Tm1, and the first-fifth switching transistor Tm5 is turned-on by the second driving voltage VSL of the low voltage level L which is applied to the first-first control node Nq11 through the first-fourth switching transistor Tm4. Accordingly, in the first selection circuit 170A, the first pass control signal Smo of the low voltage level L corresponding to the second driving voltage VSL which is supplied through the second driving voltage line DVL2 is supplied to the first pass control transistor Tma of the current path circuit 150 through the first-fifth switching transistor Tm5 and the first output node Nmo, and thus, the first pass control transistor Tma is turned-on.

In the second selection circuit 170B during the initialization period P1, the second-first and second-fourth switching transistors Tr1 and Tr4 are turned-off by the first scan signal SCAN1 of the high voltage level H, the second-second and second-third switching transistors Tr2 and Tr3 maintain turned-on state by the voltage of the second-second control node Nq22 which is maintained at the low voltage level L by the second-second capacitor Cr2, and the second-fifth switching transistor Tr5 is turned-off by the first driving voltage VSH of the high voltage level H which is applied to the second-first control node Nq21 through the second-second switching transistor Tr2. Accordingly, in the second selection circuit 170B, the second pass control signal Sro of the high voltage level H corresponding to the first driving voltage VSH which is supplied through the first driving voltage line DVL1 is supplied to the second pass control transistor Tre of the current path circuit 150 through the second-third switching transistor Tr3 and the second output node Nro, and thus, the second pass control transistor Tre remains turned-off state. Therefore, in the light emitting part 110 during the initialization period P1, a current path bypassing the first light emitting device ED1 and flowing through the first pass control transistor Tma, the second light emitting device ED2, and the driving transistor Tdr is formed.

Referring to FIGS. 8 and 9B, in the pixel circuit 130 during the sampling/data programming period P2, the first, second, and seventh transistors T1, T2, and T7 are turned-on based on the first scan signal SCAN1 of a low voltage level L, the third and fourth transistors T3 and T4 remain turned-off state by the emission control signal EM of the high voltage level H, and the fifth and sixth transistors T5 and T6 are turned-off by the second scan signal SCAN2 of a high voltage level H. Accordingly, the gate electrode (or first node N1) and the drain electrode (or second node N2) of the driving transistor Tdr are shorted (or connected), so that a threshold voltage of the driving transistor Tdr is sampled at the first node N1, and a data voltage Vdata which is supplied through the data line DL is applied to the fourth node N4, and thus, the data voltage reflecting the threshold voltage of the driving transistor Tdr may be stored in the first capacitor C1.

During the sampling/data programming period P2, the selection circuit 170 (or sub-selection circuit 171) maintains the first pass control signal Smo of the low voltage level L and the second pass control signal Sro of the high voltage level H which are output to the current path circuit 150, based on the first scan signal SCAN1 of the low voltage level L, the second scan signal SCAN2 of the high voltage level H, the first selection signal SEL1 of the high voltage level H, and the second selection signal SEL2 of the low voltage level L.

In the first selection circuit 170A during the sampling/data programming period P2, the first-first and first-fourth switching transistors Tm1 and Tm4 are turned-off by the second scan signal SCAN2 of the high voltage level H, the first-second and first-third switching transistors Tm2 and Tm3 maintain turned-off state by the voltage of the first-second control node Nq12 which is maintained at the high voltage level H by the first-second capacitor Cm2, and the first-fifth switching transistor Tm5 remains turned-on state by the voltage of the first-first control node Nq11 which is maintained at the low voltage level L by the first-first capacitor Cm1. Accordingly, in the first selection circuit 170A, the first pass control signal Smo which is supplied to the first pass control transistor Tma of the current path circuit 150 may be maintained at the low voltage level L.

In the second selection circuit 170B during the sampling/data programming period P2, the second-first and second-fourth switching transistors Tr1 and Tr4 are turned-on by the first scan signal SCAN1 of the low voltage level L, the second-second and second-third switching transistors Tr2 and Tr3 maintain turned-on state by the second selection signal SEL2 of the low voltage level L which is applied to the second-second control node Nq22 through the second-first switching transistor Tr1, and the second-fifth switching transistor Tr5 is turned-off by the first driving voltage VSH of the high voltage level H which is applied to the second-first control node Nq21 through the second-second switching transistor Tr2. Accordingly, in the second selection circuit 170B, the second pass control signal Sro which is supplied to the second pass control transistor Tre of the current path circuit 150 may be maintained at the high voltage level H. Therefore, in the light emitting part 110 during the sampling/data programming period P2, the current path bypassing the first light emitting device ED1 and flowing through the first pass control transistor Tma, the second light emitting device ED2, and the driving transistor Tdr is maintained as is.

Referring to FIGS. 8 and 9C, in the pixel circuit 130 during the holding period P3, the first, second, and seventh transistors T1, T2, and T7 are turned-off by the first scan signal SCAN1 of the high voltage level H, the third and fourth transistors T3 and T4 remain turned-off state by the emission control signal EM of the high voltage level H, and the fifth and sixth transistors T5 and T6 remain turned-off state by the second scan signal SCAN2 of the high voltage level H. During the holding period P3, since the first to seventh transistors T1 to T7 are turned-off, the gate voltage and source voltage of the driving transistor Tdr are maintained as is.

During the holding period P3, the selection circuit 170 (or sub-selection circuit 171) maintains the first pass control signal Smo of the low voltage level L and the second pass control signal Sro of the high voltage level H which are output to the current path circuit 150, based on the first scan signal SCAN1 of the low voltage level L, the second scan signal SCAN2 of the high voltage level H, the first selection signal SEL1 of the high voltage level H, and the second selection signal SEL2 of the low voltage level L. Therefore, in the light emitting part 110 during the holding period P3, the current path bypassing the first light emitting device ED1 and flowing through the first pass control transistor Tma, the second light emitting device ED2, and the driving transistor Tdr is maintained as is.

Referring to FIGS. 8 and 9D, in the pixel circuit 130 during the emission modulation period P4, the selection circuit 170 (or sub-selection circuit 171) maintains the first pass control signal Smo of the low voltage level L and the second pass control signal Sro of the high voltage level H which are output to the current path circuit 150, based on the first scan signal SCAN1 of the low voltage level L, the second scan signal SCAN2 of the high voltage level H, the first selection signal SEL1 of the high voltage level H, and the second selection signal SEL2 of the low voltage level L. Therefore, in the light emitting part 110 during the emission modulation period P4, the current path bypassing the first light emitting device ED1 and flowing through the first pass control transistor Tma, the second light emitting device ED2, and the driving transistor Tdr is maintained as is.

In the pixel circuit 130 during a duty-on period of the light emission modulation period P4, the first, second, and seventh transistors T1, T2, and T7 remain turned-off state by the first scan signal SCAN1 of the high voltage level H, the third and fourth transistors T3 and T4 are turned-on based on the emission control signal EM of the low voltage level L (or the duty-on period), and the fifth and sixth transistors T5 and T6 remain turned-off state by the second scan signal SCAN2 of the high voltage level H. Accordingly, the reference voltage Vref which is supplied through the reference voltage line RL is applied to the fourth node N4 through the third transistor T3, and as the fourth transistor T4 is turned-on, a driving current flows to the driving transistor Tdr, causing the second light emitting device ED2 to emit light. For example, the second light emitting device ED2 may emit light by a data current proportional to the square of a differential voltage between the data voltage and the reference voltage regardless of the threshold voltage of the driving transistor Tdr.

Referring to FIGS. 8 and 9E, in the pixel circuit 130 during a duty-off period of the emission modulation period P4, the first, second, and seventh transistors T1, T2, and T7 remain turned-off state by the first scan signal SCAN1 of the high voltage level H, the third and fourth transistors T3 and T4 are turned-off by the emission control signal EM of the high voltage level H (or the duty-off period), and the fifth and sixth transistors T5 and T6 remain turned-off state by the second scan signal SCAN2 of the high voltage level H. Accordingly, as the fourth transistor T4 is turned-off, the driving current flowing through the driving transistor Tdr is blocked (or cut off), so that the second light emitting device ED2 does not emit light. For example, in the emission modulation period P4, an emission time of the light emitting part 110 or a luminance (or grayscale) of the sub-pixel SP may be controlled based on the duty-on period of the emission control signal EM.

As described above, even if the open defect occurs in the first light emitting device ED1 among the first and second light emitting devices ED1 and ED2 connected in series, a current path bypassing the first light emitting device ED1 is formed by the current path circuit 150, and thus, the second light emitting device ED2 may normally emit light. Accordingly, according to an embodiment of the present disclosure, the emission defect (or failure) of the sub-pixel SP caused by a defect (or failure) in the light emitting devices ED1 and ED2 may be minimized or prevented.

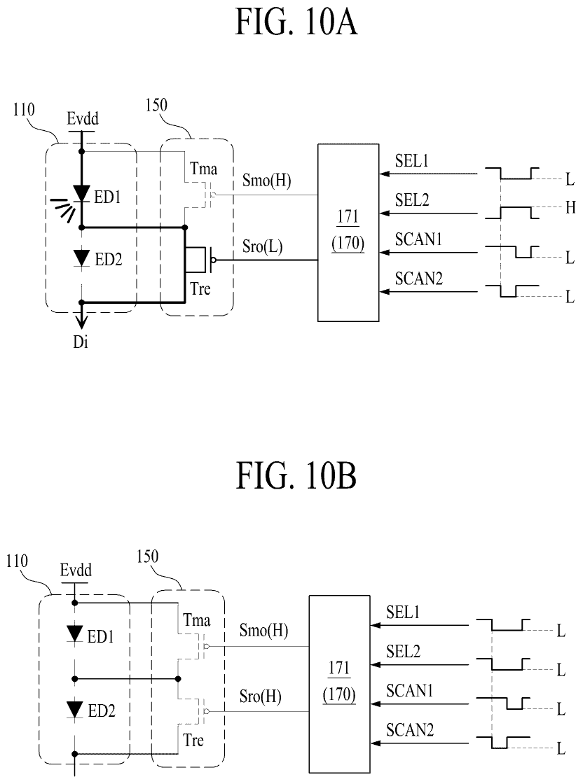

FIGS. 10A and 10B are diagrams illustrating current paths and light emission of a light emitting part in a light emitting diode display apparatus according to an embodiment of the present disclosure.

Referring to FIG. 10A, according to an embodiment of the present disclosure, when an open defect occurs in the second light emitting device ED2 among the first and second light emitting devices ED1 and ED2 in the light emitting part 110, a driving current Di flowing through the light emitting part 110 may be controlled to flow through the first light emitting device ED1 and the second pass control transistor Tre.

The selection circuit 170 (or sub-selection circuit 171) may output the first pass control signal Smo of a high voltage level H and the second pass control signal Sro of a low voltage level L, based on the first selection signal SEL1 of the low voltage level L, the second selection signal SEL2 of the high voltage level H, the first scan signal SCAN1 of the low voltage level L, and the second scan signal SCAN2 of the low voltage level L. Accordingly, the first pass control transistor Tma of the current path circuit 150 may be turned-off by to the first pass control signal Smo of the high voltage level H, and the second pass control transistor Tre of the current path circuit 150 may be turned-on by the second pass control signal Sro of the low voltage level L. Therefore, in the light emitting part 110, a current path flowing through the first light emitting device ED1 and the second pass control transistor Tre is formed, and thus, only the first light emitting device ED1 may emit light.

Except for that the selection circuit 170 (or sub-selection circuit 171) outputs the first pass control signal Smo of the high voltage level H and the second pass control signal Sro of the low voltage level L based on the first selection signal SEL1 of the low voltage level L and the second selection signal SEL2 of the high voltage level H, operations of the selection circuit 170 (or sub-selection circuit 171) may be similar to operations of the selection circuit 170 (or sub-selection circuit 171) described above with reference to FIGS. 8 to 9E, and thus, the repetitive description thereof may be omitted.

Therefore, even if the open defect occurs in the second light emitting device ED2 among the first and second light emitting devices ED1 and ED2 connected in series, a current path bypassing the second light emitting device ED2 is formed by the current path circuit 150, and thus, the first light emitting device ED1 may normally emit light. Accordingly, according to an embodiment of the present disclosure, the emission defect (or failure) of the sub-pixel SP caused by a defect (or failure) in the light emitting devices ED1 and ED2 may be minimized or prevented.

Referring to FIG. 10B, according to an embodiment of the present disclosure, when open defects occur in both the first and second light emitting devices ED1 and ED2 of the light emitting part 110, the driving current Di flowing through the light emitting part 110 can be controlled to be blocked (or cut off).

As described above with reference to FIGS. 6 to 7B, the selection circuit 170 (or sub-selection circuit 171) may output the first pass control signal Smo and the second pass control signal Sro of a high voltage level H based on the first selection signal SEL1 of the low voltage level L, the second selection signal SEL2 of the low voltage level L, the first scan signal SCAN1 of the low voltage level L, and the second scan signal SCAN2 of the low voltage level L. Accordingly, the first pass control transistor Tma of the current path circuit 150 may be turned-off by the first pass control signal Smo of the high voltage level H, and the second pass control transistor Tre of the current path circuit 150 may be turned-off by the second pass control signal Sro of the high voltage level H.

Therefore, in the light emitting part 110, a current path flowing through the first and second light emitting devices ED1 and ED2 is blocked (or cut off), and a current path through the current path circuit 150 is also blocked due to turn-off of the first and second pass control transistors Tma and Tre of the current path circuit 150, and thus, the light emitting part 110 may be dark-spotted (or may have a dark spot). For example, if open defects occur in both the first and second light emitting devices ED1 and ED2, when the driving current Di flowing through the light emitting part 110 is bypassed through the current path circuit 150, since a short circuit is formed, both the first and second pass control transistors Tma and Tre of the current path circuit 150 may be turned-off to prevent or reduce formation of the short circuit.

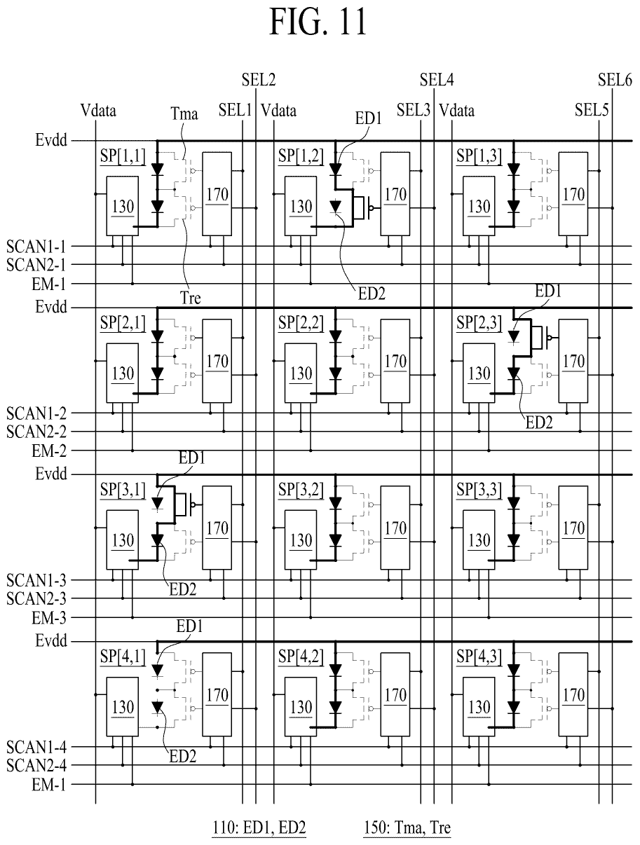

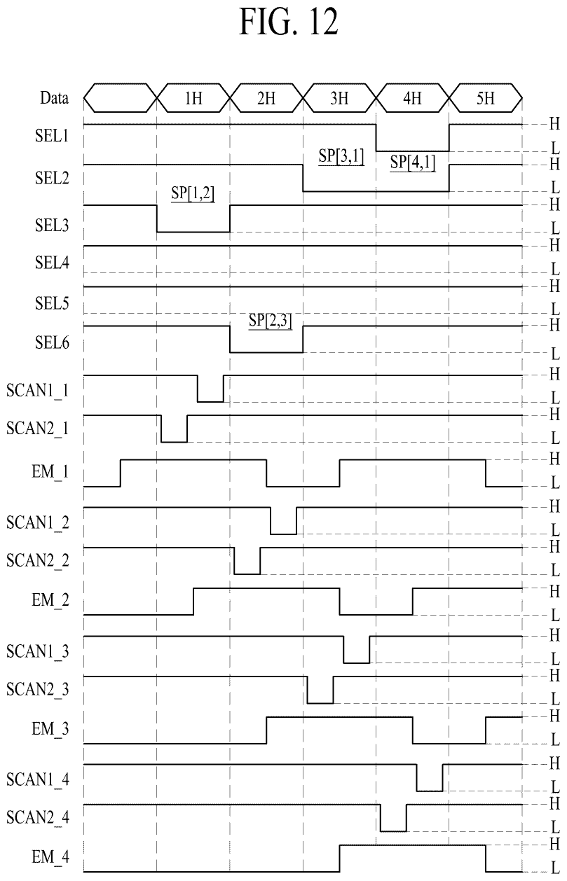

FIG. 11 is a diagram illustrating a plurality of sub-pixels in a light emitting diode display apparatus according to an embodiment of the present disclosure. FIG. 12 is a diagram illustrating a driving timing for a plurality of sub-pixels illustrated in FIG. 11. FIGS. 11 and 12 are diagrams for describing a repair method of the light emitting diode display apparatus according to an embodiment of the present disclosure.

Referring to FIGS. 11 and 12, according to an embodiment of the present disclosure, when an open defect occurs in each of the second light emitting device ED2 of (1×2)^{th} sub-pixel SP[1,2], a first light emitting device ED1 of (2×3)^{th} sub-pixel SP[2,3], a first light emitting device ED1 of (3×1)^{th} sub-pixel SP[3,1], and first and second light emitting devices ED1 and ED2 of (4×1)^{th} sub-pixel SP[4,1] among (1×1)^{th} sub-pixel SP[1,1] to (4×3) sub-pixel SP[4,3], selection signals SEL1 to SEL6 may be generated in horizontal period units based on information about locations and the light emitting device of the sub-pixel SP in which the open defect occurs. For example, the selection signals SEL1 to SEL6 applied to each sub-pixel SP may be generated to form a current path that bypasses the light emitting device having the open defect in the light emitting part 110 of each sub-pixel SP.

During a first horizontal period 1H, the selection circuits 170 disposed at each of the (1×1)^{th} sub-pixel SP[1,1] and the (1×3)^{th} sub-pixel SP[1,3] may form current paths flowing through the first and second light emitting devices ED1 and ED2 by the selection signals SEL1 and SEL2 (or SEL5 and SEL6) of a corresponding high voltage level H, and thus, in each of the (1×1)^{th} sub-pixel SP[1,1] and the (1×3)^{th} sub-pixel SP[1,3], both the first and second light emitting devices ED1 and ED2 may emit light.

During the first horizontal period 1H, the selection circuit 170 disposed at the (1×2)^{th} sub-pixel SP[1,2] may form a current path flowing through the first light emitting device ED1 and the second pass control transistor Tre by the third selection signal SEL3 of the low voltage level L and the fourth selection signal SEL4 of the high voltage level H, and thus, in the (1×2)^{th} sub-pixel SP[1,2], the first light emitting device ED1 may normally emit light, an emission defect (or failure) of the (1×2)^{th} sub-pixel SP[1,2] caused by an open defect in the second light emitting device ED2 may be prevented or reduced.

During a second horizontal period 2H, the selection circuits 170 disposed at each of the (2×1)^{th} sub-pixel SP[2,1] and the (2×2)^{th} sub-pixel SP[2,2] may form current paths flowing through the first and second light emitting devices ED1 and ED2 by the selection signals SEL1 and SEL2 (or SEL3 and SEL4) of a corresponding high voltage level H, and thus, in each of the (2×1)^{th} sub-pixel SP[2,1] and the (2×2)^{th} sub-pixel SP[2,2], both the first and second light emitting devices ED1 and ED2 may emit light.

During the second horizontal period 2H, the selection circuit 170 disposed at the (2×3)^{th} sub-pixel SP[2,3] may form a current path flowing through the second light emitting device ED2 and the first pass control transistor Tma by the fifth selection signal SEL5 of the high voltage level H and the sixth selection signal SEL6 of the low voltage level L, and thus, in the (2×3)^{th} sub-pixel SP[2,3], the second light emitting device ED2 may normally emit light, an emission defect (or failure) of the (2×3)^{th} sub-pixel SP[2,3] caused by an open defect in the first light emitting device ED1 may be prevented or reduced.

During a third horizontal period 3H, the selection circuit 170 disposed at the (3×1)^{th} sub-pixel SP[3,1] may form a current path flowing through the second light emitting device ED2 and the first pass control transistor Tma by the first selection signal SEL1 of the high voltage level H and the second selection signal SEL2 of the low voltage level L, and thus, in the (3×1)^{th} sub-pixel SP[3,1], the second light emitting device ED2 may normally emit light, an emission defect (or failure) of the (3×1)^{th} sub-pixel SP[3,1] caused by an open defect in the first light emitting device ED1 may be prevented or reduced.

During the third horizontal period 3H, the selection circuits 170 disposed at each of the (3×2)^{th} sub-pixel SP[3,2] and the (3×3)^{th} sub-pixel SP[3,3] may form current paths flowing through the first and second light emitting devices ED1 and ED2 by the selection signals SEL3 and SEL4 (or SEL5 and SEL6) of a corresponding high voltage level H, and thus, in each of the (3×2)^{th} sub-pixel SP[3,2] and the (3×3)^{th} sub-pixel SP[3,3], both the first and second light emitting devices ED1 and ED2 may emit light.

During a fourth horizontal period 4H, the selection circuit 170 of the (4×1)^{th} sub-pixel SP[4,1] may block current paths flowing through the first and second pass control transistors Tma and Tre by the first selection signal SEL1 of the low voltage level L and the second selection signal SEL2 of the low voltage level L, and thus, the (4×1)^{th} sub-pixel SP[4,1] may be dark-spotted (or may have a dark spot) due to open defects in the first and second light emitting devices ED1 and ED2, and thus, formation of the short circuit may be prevented or reduced due to turn-off of the first and second pass control transistors Tma and Tre.

During the fourth horizontal period 4H, the selection circuits 170 disposed at each of the (4×2)^{th} sub-pixel SP[4,2] and the (4×3)^{th} sub-pixel SP[4,3] may form current paths flowing through the first and second light emitting devices ED1 and ED2 by the selection signals SEL3 and SEL4 (or SEL5 and SEL6) of a corresponding high voltage level H, and thus, in each of the (4×2)^{th} sub-pixel SP[4,2] and the (4×3)^{th} sub-pixel SP[4,3], both the first and second light emitting devices ED1 and ED2 may emit light.

As described above, the light emitting diode display apparatus according to an embodiment of the present disclosure includes the current path circuit 150 and the selection circuit 170 disposed in each of the plurality of subpixels SP, and thus, even if the open defect (or short circuit defect) occurs in one light emitting device of the plurality of light emitting elements ED1 and ED2 connected in series, the remaining light emitting devices may normally emit light. Therefore, the light emitting diode display apparatus according to an embodiment of the present disclosure may minimize or prevent an emission defect (or failure) of the sub-pixel SP caused by defects (or failures) of the light emitting devices ED1 and ED2 without a separate repair process for repairing defects (or failures) of the light emitting devices ED1 and ED2.

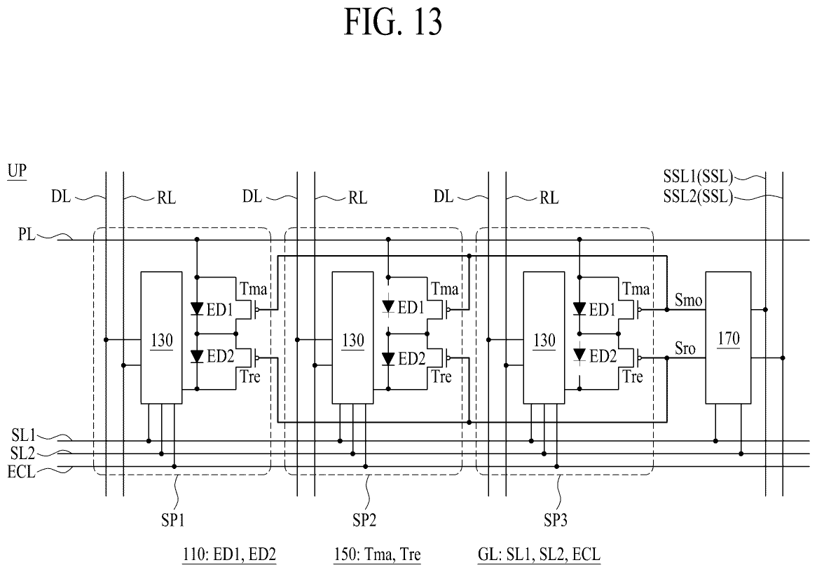

FIG. 13 is a diagram illustrating a unit pixel of a light emitting diode display apparatus according to another embodiment of the present disclosure. FIG. 13 illustrates an embodiment where the selection circuit in the light emitting diode display apparatus described above with reference to FIGS. 1 to 12 have been modified. In the following description, therefore, only a modified element will be described in detail, the other elements are referred to by the same reference numerals as FIGS. 1 to 12, and their repetitive descriptions are omitted or will be briefly given.

Referring to FIG. 13, in the light emitting diode display apparatus according to another embodiment of the present disclosure, one unit pixel (or a single unit pixel) UP may include a plurality of sub-pixels SP1, SP2, and SP3 and a selection circuit 170. For example, the one unit pixel UP may include first to third sub-pixels SP1, SP2, and SP3, but is not limited thereto.

Each of the first to third sub-pixels SP1, SP2, and SP3 may include a light emitting part 110, a pixel circuit PC, and a current path circuit 150. Each of the light emitting part 110, the pixel circuit PC, and the current path circuit 150 of each of the first to third sub-pixels SP1, SP2, and SP3 may be substantially a same as each of the light emitting part 110, the pixel circuit PC, and the current path circuit 150 described above with reference to FIGS. 2 to 4, and thus, their repetitive descriptions may be omitted.

The selection circuit 170 may be configured to be commonly connected to the first and second pass control transistors Tma and Tre of the current path circuit 150 configured in each of the first to third sub-pixels SP1, SP2, and SP3 of the one unit pixel UP. The selection circuit 170 may be configured to output a first pass control signal Smo and a second pass control signal Sro based on selection signals, a first scan signal, and a second scan signal.

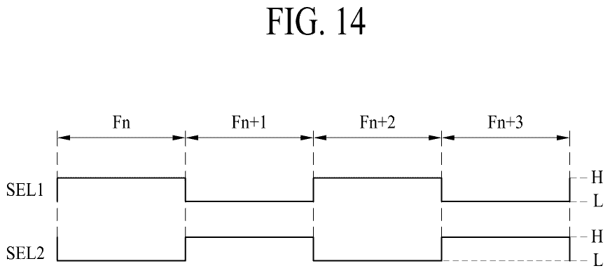

In the light emitting diode display apparatus according to another embodiment of the present disclosure, as illustrated in FIG. 14, a first selection signal SEL1 and a second selection signal SEL2 which are applied to the selection circuit 170 through a first selection signal line SSL1 and a second selection signal line SSL2 may have a voltage level (or phase) opposite to each other in units of frames.

Referring to FIGS. 13 and 14, the first selection signal SEL1 may have a high voltage level H and a low voltage level L that alternate in units of frames. For example, the first selection signal SEL1 may have the high voltage level H in odd-numbered frames Fn and Fn+2 and the low voltage level L in even-numbered frames Fn+1 and Fn+3.

The second selection signal SEL2 may a high voltage level H and a low voltage level L that alternate in units of frames. The second selection signal SEL2 may have a voltage level different from that of the first selection signal SEL1 among the high voltage level H and the low voltage level L. For example, the second selection signal SEL2 may have the low voltage level L in the odd-numbered frames Fn and Fn+2 and the high voltage level H in the even-numbered frames Fn+1 and Fn+3.

Except for that the selection circuit 170 operates based on the first and second selection signals SEL1 and SEL2 having a voltage level (or phase) opposite to each other in units of frames, the selection circuit 170 may be substantially a same as described above with reference to FIGS. 5 to 10B, and thus, the repetitive description thereof may be omitted. Therefore, descriptions of the selection circuit 170 described above with reference to FIGS. 5 to 10B may be included in descriptions of FIG. 13.

The selection circuit 170 according to an embodiment may output the first pass control signal Smo of the low voltage level L and the second pass control signal Sro of the high voltage level H based on the first selection signal SEL1 of the high voltage level H and the second selection signal SEL2 of the low voltage level L in the odd-numbered frames Fn and Fn+2.

Referring to FIGS. 5 and 13, in the odd-numbered frames Fn and Fn+2, a first selection circuit 170A of the selection circuit 170 may commonly supply the first pass control signal Smo of the low voltage level L to the first pass control transistors Tma of the current path circuits 150 which is configured in each of the first to third sub-pixels SP1, SP2, and SP3 based on the first selection signal SEL1 of the high voltage level H and the second selection signal SEL2 of the low voltage level L. A second selection circuit 170B of the selection circuit 170 may commonly supply the second pass control signal Sro of the high voltage level H to the second pass control transistors Tre of the current path circuits 150 which is configured in each of the first to third sub-pixels SP1, SP2, and SP3 based on the first selection signal SEL1 of the high voltage level H and the second selection signal SEL2 of the low voltage level L.

The selection circuit 170 according to an embodiment may output the first pass control signal Smo of the high voltage level H and the second pass control signal Sro of the low voltage level L based on the first selection signal SEL1 of the low voltage level L and the second selection signal SEL2 of the high voltage level H in the even-numbered frames Fn+1 and Fn+3.

Referring to FIGS. 5 and 13, in the even-numbered frames Fn+1 and Fn+3, the first selection circuit 170A of the selection circuit 170 may commonly supply the first pass control signal Smo of the high voltage level H to the first pass control transistor Tma of the current path circuit 150 which is configured in each of the first to third sub-pixels SP1, SP2, and SP3 based on the first selection signal SEL1 of the low voltage level L and the second selection signal SEL2 of the high voltage level H. The second selection circuit 170B of the selection circuit 170 may commonly supply the second pass control signal Sro of the low voltage level L to the second pass control transistor Tre of the current path circuit 150 which is configured in each of the first to third sub-pixels SP1, SP2, and SP3 based on the first selection signal SEL1 of the low voltage level L and the second selection signal SEL2 of the high voltage level H.

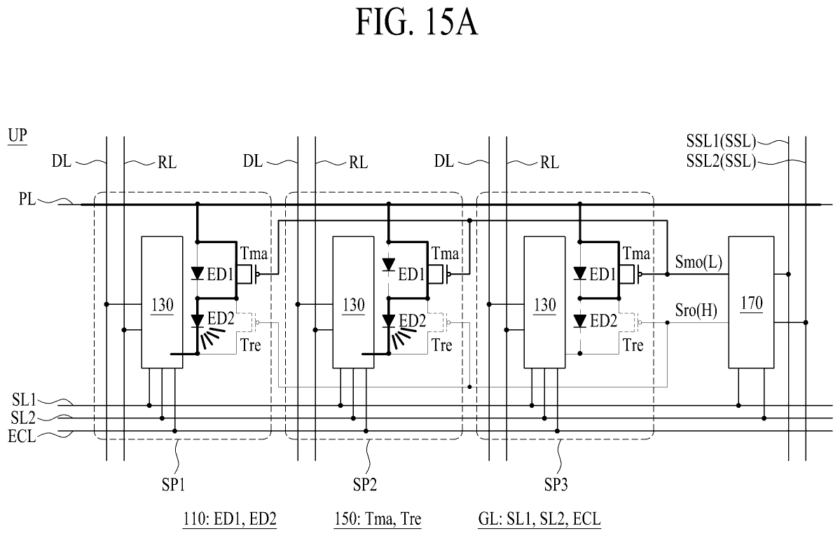

FIGS. 15A and 15B are diagrams illustrating current paths and light emission of a light emitting part configured in each of a plurality of sub-pixels in a light emitting diode display apparatus according to another embodiment of the present disclosure. FIGS. 15A and 15B are drawings illustrating operations of the sub-pixel depending on an open defect of the first light emitting device of the second sub-pixel and the second light emitting device of the third sub-pixel in one unit pixel illustrated in FIG. 13.

Referring to FIG. 15A, in the odd-numbered frames Fn and Fn+2 of the light emitting diode display apparatus according to another embodiment of the present disclosure, the selection circuit 170 of the unit pixel UP may commonly supply the first pass control signal Smo of the low voltage level L to the first pass control transistor Tma of the current path circuit 150 which is configured in each of the first to third sub-pixels SP1, SP2, and SP3, and may commonly supply the second pass control signal Sro of the high voltage level H to the second pass control transistor Tre of the current path circuit 150 which is configured in each of the first to third sub-pixels SP1, SP2, and SP3. Accordingly, during the odd-numbered frames Fn and Fn+2, each of the first and second sub-pixels SP1 and SP2 may emit light by emission of the second light emitting device ED2 due to a current pass flowing through the first pass control transistor Tma and the second light emitting device ED2, and the third sub-pixel SP3 does not emit light due to non-emission of the second light emitting device ED2 having an open defect.

Referring to FIG. 15B, in the even-numbered frames Fn+1 and Fn+3 of the light emitting diode display apparatus according to another embodiment of the present disclosure, the selection circuit 170 of the unit pixel UP may commonly supply the first pass control signal Smo of the high voltage level H to the first pass control transistor Tma of the current path circuit 150 which is configured in each of the first to third sub-pixels SP1, SP2, and SP3, and may commonly supply the second pass control signal Sro of the low voltage level L to the second pass control transistor Tre of the current path circuit 150 which is configured in each of the first to third sub-pixels SP1, SP2, and SP3. Accordingly, during the even-numbered frames Fn+1 and Fn+3, each of the first and third sub-pixels SP1 and SP3 may emit light by emission of the first light emitting device ED1 due to a current pass flowing through the first light emitting device ED1 and the second pass control transistor Tre, and the second sub-pixel SP2 does not emit light due to non-emission of the first light emitting device ED1 having an open defect.

A driving method of the sub-pixel SP according to another embodiment of the present disclosure may be substantially a same as the driving method described above with reference to FIGS. 8 to 9E except for the operations of the selection circuit, and thus, the repetitive description thereof may be omitted. For example, an operation method of the selection circuit in the driving method of the pixel circuit described above with reference to FIGS. 8 to 9E may be changed to (or replaced with) the operation method of the selection circuit 170 (or the sub-selection circuit 171) described above with reference to FIGS. 14 to 15B.

Therefore, according to the light emitting diode display apparatus of another embodiment of the present disclosure, even if the open defect (or short circuit defect) occurs in one light emitting device of the plurality of light emitting devices ED1 and ED2 connected in series in each of the first and third sub-pixels SP1 and SP3, the remaining light emitting devices may normally emit light by alternating driving in units of frames. Therefore, the light emitting diode display apparatus according to an embodiment of the present disclosure may minimize or prevent an emission defect (or failure) of the sub-pixel SP caused by defects (or failures) of the light emitting devices ED1 and ED2 without a separate repair process for repairing defects (or failures) of the light emitting devices ED1 and ED2. Furthermore, according to the light emitting diode display apparatus according to another embodiment of the present disclosure, one selection circuit 170 is disposed (or configured) in the one unit pixel UP having a plurality of sub-pixels SP1, SP2, and SP3, and thus, the number of selection signal lines required to drive the selection circuit 170 may be reduced.

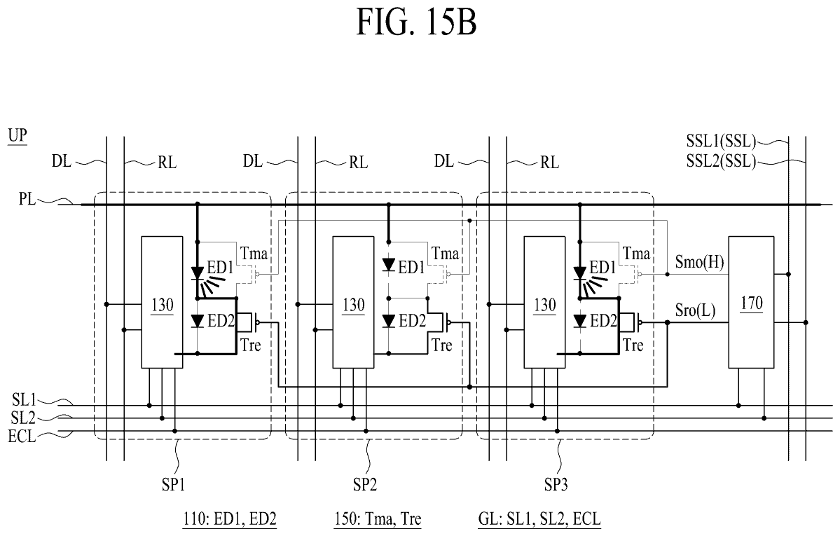

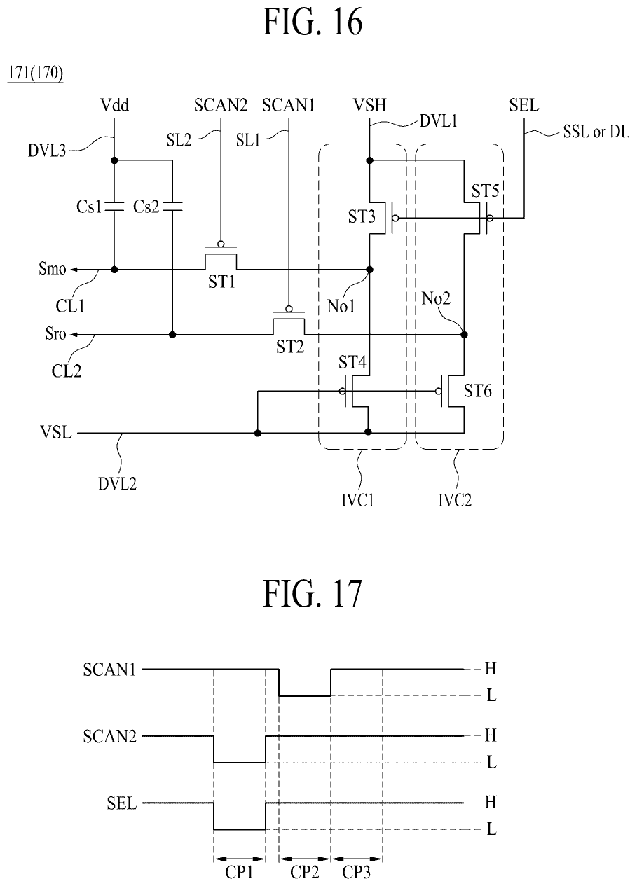

FIG. 16 is a diagram illustrating a selection circuit according to another embodiment of the present disclosure illustrated in FIG. 2.

Referring to FIGS. 2 and 16, the selection circuit 170 (or the sub-selection circuit 171) according to another embodiment of the present disclosure may include a first connection line CL1, a second connection line CL2, a first output node No1, a second output node No2, a first switching transistor ST1, a second switching transistor ST2, a first inverter circuit IVC1, a second inverter circuit IVC2, a first capacitor Cs1, and a second capacitor Cs2.

The first connection line CL1 may be configured to be electrically connected to the first pass control transistor Tma of the current path circuit 150. For example, the first connection line CL1 may be electrically connected to the gate electrode of the first pass control transistor Tma.

The second connection line CL2 may be configured to be electrically connected to the second pass control transistor Tre of the current path circuit 150. For example, the second connection line CL2 may be electrically connected to the gate electrode of the second pass control transistor Tre.

The first switching transistor ST1 is turned-on based on the second scan signal and may be connected between the first connection line CL1 and the first output node No1. The first switching transistor ST1 may output a voltage of the first output node No1 to the first connection line CL1 based on the second scan signal. For example, the first switching transistor ST1 may include a gate electrode connected to the second scan line SL2, a source electrode (or a drain electrode) connected to the first output node No1, and a drain electrode (or a source electrode) connected to the first connection line CL1.

The second switching transistor ST2 is turned-on based on the first scan signal and may be connected between the second connection line CL2 and the second output node No2. The second switching transistor ST2 may output a voltage of the second output node No2 to the second connection line CL2 based on the first scan signal. For example, the second switching transistor ST2 may include a gate electrode connected to the first scan line SL1, a source electrode (or a drain electrode) connected to the second output node No2, and a drain electrode (or a source electrode) connected to the second connection line CL2.

The first inverter circuit IVC1 may be configured to supply any one of a first driving voltage VSH supplied from a first driving voltage line DVL1 and a second driving voltage VSL supplied from a second driving voltage line DVL2 to the first output node No1 based on the selection signal SEL.

The first inverter circuit IVC1 according to an embodiment may include a third switching transistor ST3 and a fourth switching transistor ST4.

The third switching transistor ST3 is turned-on based on the selection signal SEL and may be connected between the first driving voltage line DVL1 and the first output node No1. The third switching transistor ST3 may supply the first driving voltage VSH supplied through the first driving voltage line DVL1 to the first output node No1 based on the selection signal SEL. For example, the third switching transistor ST3 may include a gate electrode connected to the selection signal line SSL, a source electrode (or a drain electrode) connected to the first driving voltage line DVL1, and a drain electrode (or a source electrode) connected to the first output node No1.

The fourth switching transistor ST4 is turned-on based on the second driving voltage VSL and may be connected between the second driving voltage line DVL2 and the first output node No1. The fourth switching transistor ST4 may supply the second driving voltage VSL supplied through the second driving voltage line DVL2 to the first output node No1 based on the second driving voltage VSL. For example, the fourth switching transistor ST4 may include a gate electrode connected to the second driving voltage line DVL2, a source electrode (or a drain electrode) connected to the second driving voltage line DVL2, and a drain electrode (or a source electrode) connected to the first output node No1.

The second inverter circuit IVC2 may be configured to supply any one of the first driving voltage VSH supplied from the first driving voltage line DVL1 and the second driving voltage VSL supplied from the second driving voltage line DVL2 to the second output node No2 based on the selection signal SEL.

The second inverter circuit IVC2 according to an embodiment may include a fifth switching transistor ST5 and a sixth switching transistor ST6.

The fifth switching transistor ST5 is turned-on based on the selection signal SEL and may be connected between the first driving voltage line DVL1 and the second output node No2. The fifth switching transistor ST5 may supply the first driving voltage VSH supplied through the first driving voltage line DVL1 to the second output node No2 based on the selection signal SEL. For example, the fifth switching transistor ST5 may include a gate electrode connected to the selection signal line SSL, a source electrode (or a drain electrode) connected to the first driving voltage line DVL1, and a drain electrode (or a source electrode) connected to the second output node No2.

The sixth switching transistor ST6 is turned-on based on the second driving voltage VSL and may be connected between the second driving voltage line DVL2 and the second output node No2. The sixth switching transistor ST6 may supply the second driving voltage VSL supplied through the second driving voltage line DVL2 to the second output node No2 based on the second driving voltage VSL. For example, the sixth switching transistor ST6 may include a gate electrode connected to the second driving voltage line DVL2, a source electrode (or a drain electrode) connected to the second driving voltage line DVL2, and a drain electrode (or a source electrode) connected to the second output node No2.

The first capacitor Cs1 may be connected between the third driving voltage line DVL3 and the first connection line CL1. The first capacitor Cs1 may store a differential voltage between a voltage of the third driving voltage line DVL3 and a voltage of the first connection line CL1. For example, the first capacitor Cs1 may maintain the voltage of the first connection line CL1 during one frame. For example, the third driving voltage Vdd may be a high-potential voltage or a high logic voltage. For example, the third driving voltage Vdd may have a same voltage level as the first driving voltage VSH, but is not limited thereto.

The second capacitor Cs2 may be connected between the third driving voltage line DVL3 and the second connection line CL2. The second capacitor Cs2 may store a differential voltage between a voltage of the third driving voltage line DVL3 and a voltage of the second connection line CL2. For example, the second capacitor Cs2 may maintain the voltage of the second connection line CL2 during one frame. The second capacitor Cs2 may be configured to have a same capacitance as the first capacitor Cs1, but is not limited thereto. For example, the first capacitor Cs1 and the second capacitor Cs2 may be configured to have a same or different capacitance as the second capacitor C2 in the pixel circuit 130.

The first to sixth switching transistors ST1 to ST6 may be configured as a same or different thin-film transistors among P-type and N-type thin-film transistors. One or more of the first to sixth switching transistors ST1 to ST6 may include a same or different semiconductor layers of an amorphous silicon, a polycrystalline silicon, a low-temperature polycrystalline silicon, an oxide, or an organic material. The first to sixth switching transistors ST1 to ST6 may be formed (or configured) together with the transistors of the pixel circuit 130. In the following description, the first to sixth switching transistors ST1 to ST6 are described as the P-type thin-film transistor.

According to another embodiment of the present disclosure, each data line DL configured in each of the plurality of sub-pixels SP may be used as the selection signal line SSL. Each data line DL configured in each of the plurality of sub-pixels SP may be commonly connected to the pixel circuit 130 and the selection circuit 170 (or sub-selection circuit 171). Each data line DL configured in each of the plurality of sub-pixels SP may be driven to supply the selection signal SEL synchronized with any one of the first scan signal or the second scan signal from the panel driving circuit part to the selection circuit 170 (or sub-selection circuit 171), and then supply the data signal to a corresponding pixel circuit 130. Accordingly, the selection signal line connected to the selection circuit 170 (or sub-selection circuit 171) in each of the plurality of sub-pixels SP may be omitted.

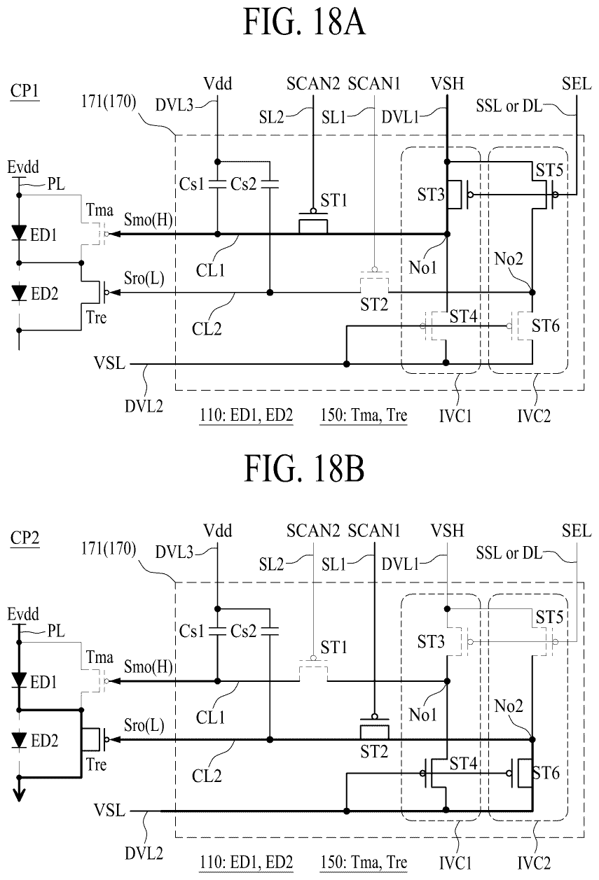

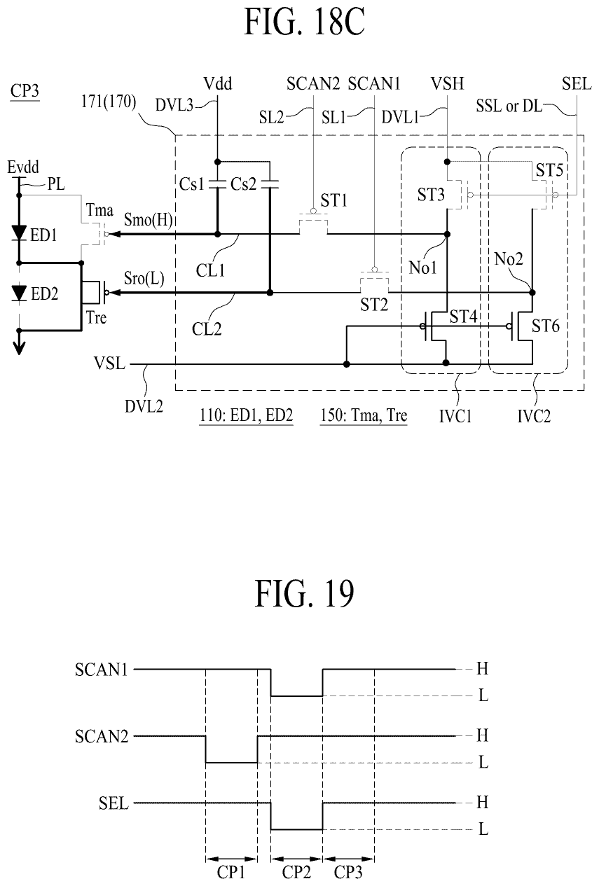

FIG. 17 is a diagram illustrating a driving timing of the selection circuit illustrated in FIG. 16. FIGS. 18A to 18C are diagrams illustrating operations of the selection circuit based on the driving timing illustrated in FIG. 17. FIGS. 16 and 18A to 18C are diagrams illustrating operations of the selection circuit depending on an open defect of the second light emitting device among the first light emitting device and the second light emitting device illustrated in FIG. 2.

Referring to FIGS. 17 and 18A, according to another embodiment of the present disclosure, the selection signal SEL based on an open defect of the second light emitting device ED2 may have a low voltage level L synchronized with the second scan signal SCAN2 of low voltage level L.

During the first current pass formation period CP1 synchronized with the second scan signal SCAN2 of the low voltage level L, the selection circuit 170 (or sub-selection circuit 171) may output a first pass control signal Smo of a high voltage level H to the current path circuit 150 based on the first scan signal SCAN1 of the high voltage level H, the second scan signal SCAN2 of the low voltage level L, and the selection signal SEL of the low voltage level L.

In the selection circuit 170 (or sub-selection circuit 171) during the first current pass formation period CP1, the first switching transistor ST1 is turned-on based on the second scan signal SCAN2 of the low voltage level L, the second switching transistor ST2 is turned-off based on the first scan signal SCAN1 of the high voltage level H, the third and fifth switching transistors ST3 and ST5 are turned-on based on the selection signal SEL of the low voltage level L, and the fourth and sixth switching transistors ST4 and ST6 are turned-off by gate-source voltages thereof. Accordingly, the first pass control signal Smo of the high voltage level H corresponding to the first driving voltage VSH which is supplied through the first driving voltage line DVL1 is supplied to the first pass control transistor Tma of the current path circuit 150 through the third switching transistor ST3, the first output node No1, the first switching transistor ST1, and the first connection line CL1, and thus, the first pass control transistor Tma is turned-off. The first capacitor Cs1 may be charged with the voltage of the first connection line CL1.

In the light emitting part 110 during the first current pass formation period CP1, a current pass flowing to the first light emitting device ED1 is formed as the first pass control transistor Tma is turned-off.

Referring to FIGS. 17 and 18B, during the second current pass formation period CP2 synchronized with the first scan signal SCAN1 of the low voltage level L, the selection circuit 170 (or sub-selection circuit 171) may output the first pass control signal Smo of the high voltage level H and the second pass control signal Sro of the low voltage level L to the current path circuit 150 based on the first scan signal SCAN1 of the low voltage level L, the second scan signal SCAN2 of the high voltage level H, and the selection signal SEL of the high voltage level H.

In the selection circuit 170 (or sub-selection circuit 171) during the second current pass formation period CP2, the first switching transistor ST1 is turned-off based on the second scan signal SCAN2 of the high voltage level H, the second switching transistor ST2 is turned-on based on the first scan signal SCAN1 of the low voltage level L, the third and fifth switching transistors ST3 and ST5 are turned-off based on the selection signal SEL of the high voltage level H, and the fourth and sixth switching transistors ST4 and ST6 are turned-on based on the second driving voltage VSL of the low voltage level L. Accordingly, since a voltage of the first connection line CL1 is maintained by the first capacitor Cs1, the first pass control signal Smo which is supplied to the first pass control transistor Tma of the current path circuit 150 may be maintained at the high voltage level H. In addition, the second pass control signal Sro of the low voltage level L corresponding to the second driving voltage VSL which is supplied through the second driving voltage line DVL2 is supplied to the second pass control transistor Tre of the current path circuit 150 through the sixth switching transistor ST6, the second output node No2, the second switching transistor ST2, and the second connection line CL2, and thus, the second pass control transistor Tre is turned-on. The second capacitor Cs2 may be charged with the voltage of the second connection line CL2.

In the light emitting part 110 during the second current pass formation period CP2, a current pass flowing through the first light emitting device ED1 and the second pass control transistor Tre is formed as the first pass control transistor Tma remains in turned-off state and the second pass control transistor Tre is turned-on, and thus, the first light emitting device ED1 may emit light.

Referring to FIGS. 17 and 18C, during the third current pass formation period CP3 corresponding to the first and second scan signals SCAN1 and SCAN2 of the high voltage level H and the selection signal SEL of the high voltage level H, the selection circuit 170 (or sub-selection circuit 171) may maintain the first pass control signal Smo of the high voltage level H and the second pass control signal Sro of the low voltage level L which are output to the current path circuit 150 based on the first scan signal SCAN1 of the high voltage level H, the second scan signal SCAN2 of the high voltage level H, and the selection signal SEL of the high voltage level H.

In the selection circuit 170 (or sub-selection circuit 171) during the third current pass formation period CP3, the first switching transistor ST1 maintains the turned-off state based on the second scan signal SCAN2 of the high voltage level H, the second switching transistor ST2 is turned-off based on the first scan signal SCAN1 of the high voltage level H, the third and fifth switching transistors ST3 and ST5 maintain the turned-off state based on the selection signal SEL of the high voltage level H, and the fourth and sixth switching transistors ST4 and ST6 maintain the turned-on state based on the second driving voltage VSL of the low voltage level L. Accordingly, since the voltage of the first connection line CL1 is maintained by the first capacitor Cs1, the first pass control signal Smo which is supplied to the first pass control transistor Tma of the current path circuit 150 may be maintained at the high voltage level H. Furthermore, since the voltage of the second connection line CL2 is maintained by the second capacitor Cs2, the second pass control signal Sro which is supplied to the second pass control transistor Tre of the current path circuit 150 may be maintained at the low voltage level L as is.

In the light emitting part 110 during the third current pass formation period CP3, the turned-off state of the first pass control transistor Tma is maintained and the second pass control transistor Tre remains turned-on state, and thus, the emission state of the first light emitting device ED1 may be maintained as is.

As described above, in the selection circuit 170 (or sub-selection circuit 171) according to another embodiment of the present disclosure, even if the open defect occurs in the second light emitting device ED2 among the first and second light emitting devices ED1 and ED2 connected in series, a current path bypassing the second light emitting device ED2 is formed by the current path circuit 150, and thus, the first light emitting device ED1 may normally emit light. Therefore, according to another embodiment of the present disclosure, the emission defect (or failure) of the sub-pixel SP caused by a defect (or failure) in the light emitting devices ED1 and ED2 may be minimized or prevented.

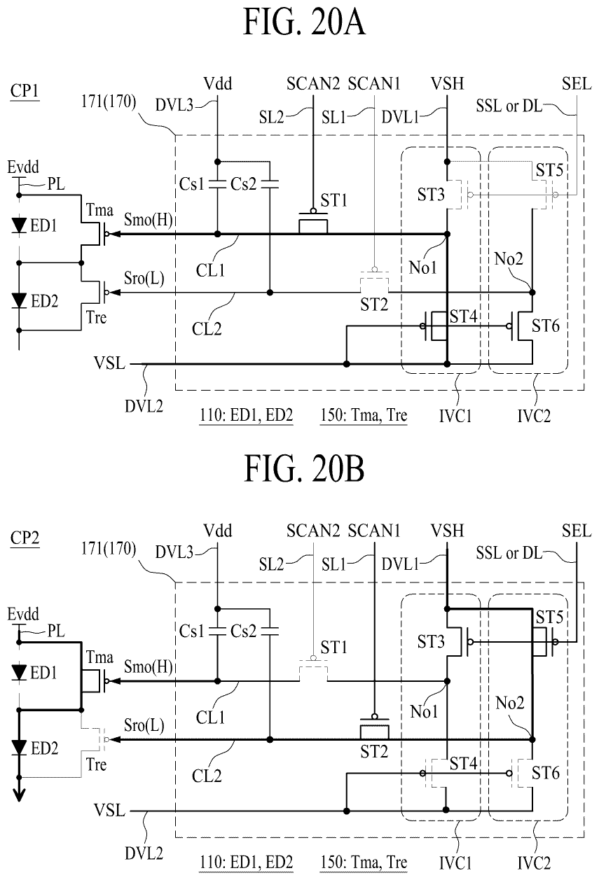

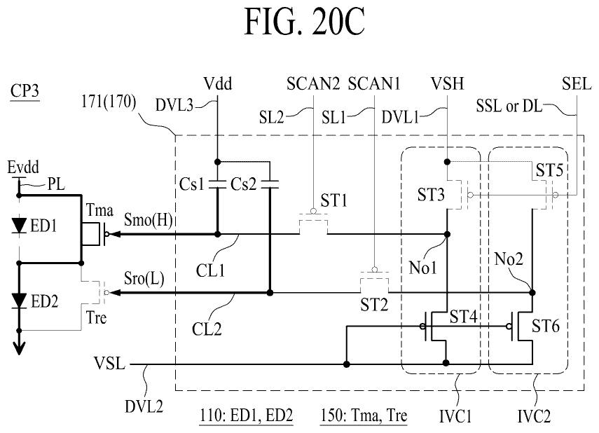

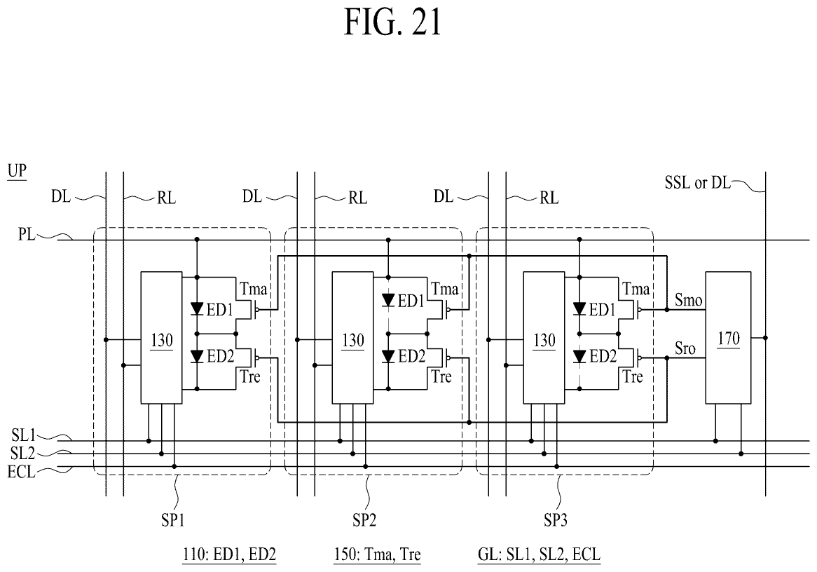

FIG. 19 is a diagram illustrating a driving timing of the selection circuit illustrated in FIG. 16. FIGS. 20A to 20C are diagrams illustrating operations of the selection circuit based on the driving timing illustrated in FIG. 19. FIGS. 19 and 20A to 20C illustrate operations of the selection circuit depending on an open defect of the first light emitting device among the first light emitting device and the second light emitting device illustrated in FIG. 2.

Referring to FIGS. 19 and 20A, according to another embodiment of the present disclosure, the selection signal SEL based on an open defect of the first light emitting device ED1 may have a low voltage level L synchronized with the first scan signal SCAN1 of low voltage level L.

During the first current pass formation period CP1 synchronized with the second scan signal SCAN2 of the low voltage level L, the selection circuit 170 (or sub-selection circuit 171) may output a first pass control signal Smo of the low voltage level L to the current path circuit 150 based on the first scan signal SCAN1 of a high voltage level H, the second scan signal SCAN2 of the low voltage level L, and the selection signal SEL of a high voltage level H.

In the selection circuit 170 (or sub-selection circuit 171) during the first current pass formation period CP1, the first switching transistor ST1 is turned-on based on the second scan signal SCAN2 of the low voltage level L, the second switching transistor ST2 is turned-off based on the first scan signal SCAN1 of the high voltage level H, the third and fifth switching transistors ST3 and ST5 are turned-off based on the selection signal SEL of the high voltage level H, and the fourth and sixth switching transistors ST4 and ST6 are turned-on based on a second driving voltage VSL of a low voltage level L. Accordingly, the first pass control signal Smo of the low voltage level L corresponding to the second driving voltage VSL which is supplied through a second driving voltage line DVL2 is supplied to the first pass control transistor Tma of the current path circuit 150 through the fourth switching transistor ST4, the first output node No1, the first switching transistor ST1, and the first connection line CL1, and thus, the first pass control transistor Tma is turned-on. The first capacitor Cs1 may be charged with the voltage of the first connection line CL1.

In the light emitting part 110 during the first current pass formation period CP1, a current path bypassing the first light emitting device ED1 having an open defect is formed as the first pass control transistor Tma is turned-off.

Referring to FIGS. 19 and 20B, during the second current pass formation period CP2 synchronized with the first scan signal SCAN1 of the low voltage level L, the selection circuit 170 (or sub-selection circuit 171) may output the first pass control signal Smo of the low voltage level L and the second pass control signal Sro of the high voltage level H to the current path circuit 150 based on the first scan signal SCAN1 of the low voltage level L, the second scan signal SCAN2 of the high voltage level H, and the selection signal SEL of the low voltage level L.

In the selection circuit 170 (or sub-selection circuit 171) during the second current pass formation period CP2, the first switching transistor ST1 is turned-off based on the second scan signal SCAN2 of the high voltage level H, the second switching transistor ST2 is turned-on based on the first scan signal SCAN1 of the low voltage level L, the third and fifth switching transistors ST3 and ST5 are turned-on based on the selection signal SEL of the low voltage level L, and the fourth and sixth switching transistors ST4 and ST6 are turned-off by gate-source voltages thereof. Accordingly, since a voltage of the first connection line CL1 is maintained by the first capacitor Cs1, the first pass control signal Smo which is supplied to the first pass control transistor Tma of the current pass circuit 150 may be maintained at the high voltage level H. In addition, the second pass control signal Sro of the high voltage level H corresponding to a first driving voltage VSH which is supplied through a first driving voltage line DVL1 is supplied to the second pass control transistor Tre of the current path circuit 150 through the fifth switching transistor ST5, the second output node No2, the second switching transistor ST2, and the second connection line CL2, and thus, the second pass control transistor Tre is turned-off. The second capacitor Cs2 may be charged with the voltage of the second connection line CL2.

In the light emitting part 110 during the second current pass formation period CP2, a current pass flowing through the first pass control transistor Tma and the second light emitting device ED2 is formed as the first pass control transistor Tma remains turned-on state and the second pass control transistor Tre is turned-off, and thus, the second light emitting device ED2 may emit light.

Referring to FIGS. 19 and 20C, during the third current pass formation period CP3 corresponding to the first and second scan signals SCAN1 and SCAN2 of the high voltage level H and the selection signal SEL of the high voltage level H, the selection circuit 170 (or sub-selection circuit 171) may maintain the first pass control signal Smo of the low voltage level L and the second pass control signal Sro of the high voltage level H which are output to the current path circuit 150 based on the first scan signal SCAN1 of the high voltage level H, the second scan signal SCAN2 of the high voltage level H, and the selection signal SEL of the high voltage level H.

In the selection circuit 170 (or sub-selection circuit 171) during the third current pass formation period CP3, the first switching transistor ST1 maintains the turned-off state based on the second scan signal SCAN2 of the high voltage level H, the second switching transistor ST2 is turned-off based on the first scan signal SCAN1 of the high voltage level H, the third and fifth switching transistors ST3 and ST5 are turned-off based on the selection signal SEL of the high voltage level H, and the fourth and sixth switching transistors ST4 and ST6 are turned-on based on the second driving voltage VSL of the low voltage level L. Accordingly, since a voltage of the first connection line CL1 is maintained by the first capacitor Cs1, the first pass control signal Smo which is supplied to the first pass control transistor Tma of the current path circuit 150 may be maintained at the low voltage level L. In addition, since the voltage of the second connection line CL2 is maintained by the second capacitor Cs2, the second pass control signal Sro which is supplied to the second pass control transistor Tre of the current path circuit 150 may be maintained at the high voltage level H as is.

In the light emitting part 110 during the third current pass formation period CP3, the turned-on state of the first pass control transistor Tma is maintained and the second pass control transistor Tre remains turned-off state, and thus, the emission state of the second light emitting device ED2 may be maintained as is.

A driving method of the sub-pixel SP including the selection circuit 170 (or sub-selection circuit 171) according to another embodiment of the present disclosure may be substantially a same as the driving method described above with reference to FIGS. 8 to 9E except for the operations of the selection circuit, and thus, the repetitive description thereof may be omitted. For example, an operation method of the selection circuit in the driving method of the pixel circuit described above with reference to FIGS. 8 to 9E may be changed to (or replaced with) the operation method of the selection circuit 170 (or the sub-selection circuit 171) described above with reference to FIGS. 16 to 20C.

As described above, the selection circuit 170 (or sub-selection circuit 171) according to another embodiment of the present disclosure may provide the same effect as the selection circuit 170 (or sub-selection circuit 171) described above with reference to FIGS. 17 and 18A to 18C.

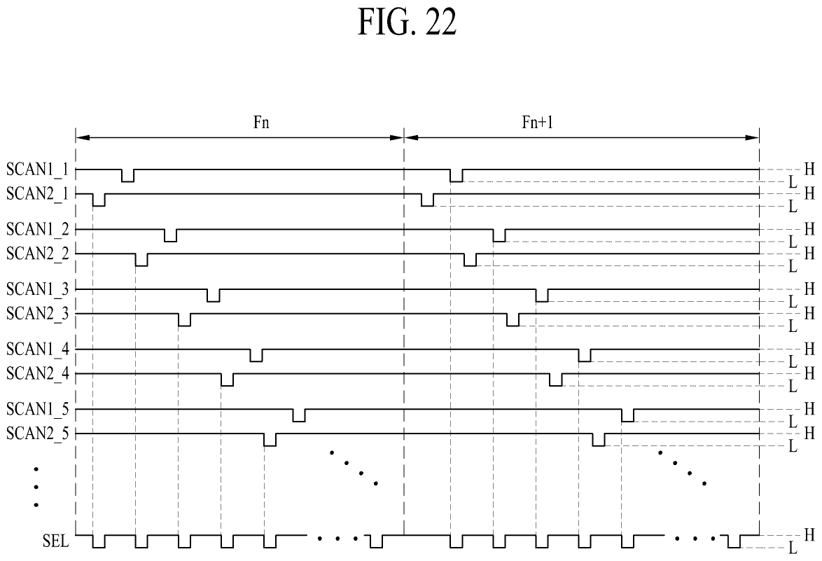

FIG. 21 is a diagram illustrating a unit pixel of a light emitting diode display apparatus according to another embodiment of the present disclosure. FIG. 21 illustrates an embodiment where the selection circuit in the light emitting diode display apparatus described above with reference to FIGS. 16 to 20C have been modified. In the following description, therefore, only a modified element will be described in detail, the other elements are referred to by the same reference numerals as FIGS. 16 to 20C, and their repetitive descriptions are omitted or will be briefly given. FIG. 22 is a diagram illustrating a selection signal according to another embodiment of the present disclosure.

Referring to FIG. 21, in the light emitting diode display apparatus according to another embodiment of the present disclosure, one unit pixel (or a single unit pixel) UP may include a plurality of sub-pixels SP1, SP2, and SP3 and a selection circuit 170. For example, the one unit pixel UP may include first to third sub-pixels SP1, SP2, and SP3, but is not limited thereto.

Each of the first to third sub-pixels SP1, SP2, and SP3 may include a light emitting part 110, a pixel circuit PC, and a current path circuit 150. Each of the light emitting part 110, the pixel circuit PC, and the current path circuit 150 of each of the first to third sub-pixels SP1, SP2, and SP3 may be substantially a same as each of the light emitting part 110, the pixel circuit PC, and the current path circuit 150 described above with reference to FIGS. 2 to 4, and thus, their repetitive descriptions may be omitted.

The selection circuit 170 may be configured to be commonly connected to the first and second pass control transistors Tma and Tre of the current path circuit 150 configured in each of the first to third sub-pixels SP1, SP2, and SP3 of the one unit pixel UP. The selection circuit 170 may be configured to output a first pass control signal Smo and a second pass control signal Sro based on selection signals, a first scan signal, and a second scan signal.

In the light emitting diode display apparatus according to another embodiment of the present disclosure, a selection signal SEL which is applied to the selection circuit 170 through a selection signal line SSL may be synchronized with a second scan signal SCAN2 in a N^{th} frame Fn (where N is a natural number) and synchronized with a first scan signal SCAN1 in a N+1^{th} frame Fn+1.

Referring to FIGS. 21 and 22, the selection signal SEL may have a high voltage level H and a low voltage level L. In the N^{th} frame (or odd-numbered frame) Fn, the low voltage level L of the selection signal SEL may be sequentially generated to be synchronized with the second scan signal SCAN2 which is applied to s second scan line SL2 of each of a plurality of gate lines GL. In addition, in the N+1^{th} frame (or even-numbered frame) Fn+1, the low voltage level L of the selection signal SEL may be sequentially generated to be synchronized with the first scan signal SCAN1 which is applied to a first scan line SL1 of each of the plurality of gate lines GL.

Except for that the selection circuit 170 operates based on the selection signal SEL synchronized with the second scan signal SCAN2 or the first scan signal SCAN1 according to the frame Fn and Fn+1, the selection circuit 170 may be substantially a same as described above with reference to FIGS. 17 to 20C, and thus, the repetitive description thereof may be omitted. Therefore, descriptions of the selection circuit 170 described above with reference to FIGS. 17 to 20C may be included in descriptions of FIG. 21.

The selection circuit 170 according to an embodiment may output a first pass control signal Smo of the high voltage level H and a second pass control signal Sro of the low voltage level L based on the selection signal SEL of the low voltage level L synchronized with the second scan signal SCAN2 in the N^{th} frame Fn, as described above with reference to FIGS. 18A to 18C.

In the N^{th} frame Fn, the first pass control signal Smo of the high voltage level H which is output from the selection circuit 170 may be commonly supplied to the first pass control transistor Tma of the current path circuit 150 configured in each of the first to third sub-pixels SP1, SP2, and SP3, and the second pass control signal Sro of the low voltage level L which is output from the selection circuit 170 may be commonly supplied to the second pass control transistor Tre of the current path circuit 150 configured in each of the first to third sub-pixels SP1, SP2, and SP3.

The selection circuit 170 according to an embodiment may output the first pass control signal Smo of the low voltage level L and the second pass control signal Sro of the high voltage level H based on the selection signal SEL of the low voltage level L synchronized with the first scan signal SCAN1 in the N+1^{th} frame Fn+1, as described above with reference to FIGS. 20A to 20C.

In the N+1^{th} frame Fn+1, the first pass control signal Smo of the low voltage level L which is output from the selection circuit 170 may be commonly supplied to the first pass control transistor Tma of the current path circuit 150 configured in each of the first to third sub-pixels SP1, SP2, and SP3, and the second pass control signal Sro of the high voltage level H which is output from the selection circuit 170 may be commonly supplied to the second pass control transistor Tre of the current path circuit 150 configured in each of the first to third sub-pixels SP1, SP2, and SP3.

Except for that operation method of the selection circuit 170 according to another embodiment of the present disclosure receives one selection signal through one selection signal line (or data line) and operates based on driving timing illustrated in FIG. 22, the operation method of the selection circuit 170 according to another embodiment of the present disclosure may be substantially a same as the operation method of the selection circuit described above with reference to FIGS. 13 to 15B, and thus, the repetitive description thereof may be omitted.

A driving method of the sub-pixel SP according to another embodiment of the present disclosure may be substantially a same as the driving method described above with reference to FIGS. 8 to 9E except for the operations of the selection circuit, and thus, the repetitive description thereof may be omitted. For example, an operation method of the selection circuit in the driving method of the pixel circuit described above with reference to FIGS. 8 to 9E may be changed to (or replaced with) the operation method of the selection circuit 170 described above with reference to FIGS. 21 and 22.

Therefore, the light emitting diode display apparatus according to another embodiment of the present disclosure may have the same effect as the light emitting diode display apparatus described above with reference to FIGS. 13 to 15B. Furthermore, in the light emitting diode display apparatus according to another embodiment of the present disclosure, one selection circuit 170 is disposed (or configured) in the one unit pixel UP having a plurality of sub-pixels SP1, SP2, and SP3, and thus, the number of selection signal lines required to drive the selection circuit 170 may be reduced.

Various examples and aspects of the present disclosure are described below. These are provided as examples, and do not limit the scope of the present disclosure.

In one or more aspects of the present disclosure, a light emitting diode display apparatus comprises a plurality of pixels having a plurality of sub-pixels. Each of the plurality of sub-pixels comprises a light emitting part having a first light emitting device and a second light emitting device connected in series, a pixel circuit configured to control a current flowing through the light emitting part based on a data signal supplied through a data line and a pixel driving signal supplied through a gate line, and a current path circuit configured to select a current path flowing through the first light emitting device and the second light emitting device. Each of the plurality of pixels includes a selection circuit configured to control the current path circuit based on a selection signal and the pixel driving signal.

Any one data line of the data lines configured in each of the plurality of sub-pixels may be used as a selection signal line. The data line used as the selection signal line may supply the selection signal synchronized with any one of a first scan signal and a second scan signal to the selection circuit, and then may supply the data signal to a corresponding pixel circuit.

The selection circuit may include a first inverter circuit and a second inverter circuit. The first inverter circuit may include a third switching transistor turned-on based on the selection signal and connected between the first driving voltage line and the first output node, and a fourth switching transistor turned-on based on the second driving voltage and connected between the second driving voltage line and the first output node. The second inverter circuit may include a fifth switching transistor turned-on based on the selection signal and connected between the first driving voltage line and the second output node, and a sixth switching transistor turned-on based on the second driving voltage and connected between the second driving voltage line and the second output node.

Each of the first light emitting device and the second light emitting device may be a micro light emitting device or a micro light emitting diode chip.

The pixel circuit may include a first node, a second node, a third node, a fourth node, a driving transistor connected to the first, second and third nodes and configured to control a current flowing from the light emitting part through the second node to the third node based on a voltage of the first node, a first transistor turned-on based on the first scan signal and connected between the data line and the fourth node, a second transistor turned-on based on the first scan signal and connected between the first node and the third node, a third transistor turned-on based on the emission control signal and connected between a reference voltage line and the fourth node, a fourth transistor turned-on based on the emission control signal and connected between a pixel common voltage line and the third node, a fifth transistor turned-on based on the second scan signal and connected between the reference voltage line and the first node, a sixth transistor turned-on based on the second scan signal and connected between the data line and the fourth node, a seventh transistor turned-on based on the first scan signal and connected between a pixel driving voltage line and the second node, a first capacitor connected between the first node and the fourth node, and a second capacitor connected between the pixel driving voltage line and the second node.

In one or more aspects of the present disclosure, a display apparatus comprises a light emitting part having a first light emitting device and a second light emitting device, a pixel circuit coupled to the light emitting part and configured to control a current flowing through the light emitting part, a current path circuit coupled to the light emitting part and configured to select a current path flowing through the first light emitting device and the second light emitting device, and a selection circuit configured to control the current path circuit based on a selection signal and a pixel driving signal.

The current path circuit may include a first pass control transistor and a second pass control transistor connected in series, and the first light emitting device and the second light emitting device may be connected in series.

When the first light emitting device is defective, the current may be prevented or reduced from flowing through the first light emitting device and may flow through the first pass control transistor and the second light emitting device.

The selection circuit may provide a first pass control signal to the first pass control transistor and a second pass control signal to the second pass control transistor.

The display apparatus may operate in multiple periods including an initialization period, a data programming period, and an emission modulation period, which may occur in sequence.

The selection circuit may maintain a same voltage level of the first pass control signal during the multiple periods while a voltage level of the selection signal during one of the multiple periods is different from a voltage level of the selection signal during another one of the multiple periods.

The pixel driving signal may include a first scan signal and a second scan signal, and the selection circuit may maintain a same voltage level of the first pass control signal during the multiple periods while a voltage level of the first scan signal during one of the multiple periods is different from a voltage level of the first scan signal during another one of the multiple periods.

Each sub-pixel may include the light emitting part, the pixel circuit, the current path circuit, and the selection circuit.

Each sub-pixel may include the light emitting part, the pixel circuit, and the current path circuit. The selection circuit may be shared by current path circuits in multiple sub-pixels.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide non-limiting examples of the technical features of the present disclosure for illustrative purposes. In other words, the disclosed embodiments illustrate the scope of the technical features of the present disclosure and are not intended to be limiting in any respect. Thus, the scope of the present disclosure is not limited to the embodiments shown, but is to be accorded the widest scope consistent with the claims and their equivalents.

What is claimed is:

1. A light emitting diode display apparatus, comprising:
a plurality of pixels having a plurality of sub-pixels,
wherein each of the plurality of sub-pixels comprises:
a light emitting part having a first light emitting device and a second light emitting device connected in series;
a pixel circuit configured to control a current flowing through the light emitting part based on a data signal supplied through a data line and a pixel driving signal supplied through a gate line; and
a current path circuit configured to select a current path flowing through the first light emitting device and the second light emitting device, and
wherein each of the plurality of pixels includes a selection circuit configured to control the current path circuit based on a selection signal and the pixel driving signal.

2. The light emitting diode display apparatus of claim 1, wherein the current flowing through the light emitting part flows through both the first light emitting device and the second light emitting device, or the current flowing through the light emitting part flows through any one of the first light emitting device and the second light emitting device and the current path circuit.

3. The light emitting diode display apparatus of claim 1, wherein the current path circuit comprises:
a first pass control transistor connected to both ends of the first light emitting device, and the first pass control transistor turned-on based on a first pass control signal supplied from the selection circuit; and
a second pass control transistor connected to both ends of the second light emitting device and turned-on based on a second pass control signal supplied from the selection circuit.

4. The light emitting diode display apparatus of claim 3, wherein the current flowing through the light emitting part flows to the pixel circuit through both the first light emitting device and the second light emitting device, or the current flowing through the light emitting part flows to the pixel circuit through any one of the first light emitting device and the second light emitting device and any one of the first pass control transistor and the second pass control transistor.

5. The light emitting diode display apparatus of claim 3, wherein:
the first pass control transistor and the second pass control transistor are alternately turned-on in units of frames, and
the first light emitting device and the second light emitting device alternately emit light in units of frames.

6. The light emitting diode display apparatus of claim 3, wherein each of the plurality of sub-pixels further includes a selection signal line configured to supply the selection signal to the selection circuit,
wherein the gate line includes:
a first scan line configured to supply a first scan signal to the pixel circuit and the selection circuit;
a second scan line configured to supply a second scan signal to the pixel circuit and the selection circuit; and
an emission control line configured to supply an emission control signal to the pixel circuit, and
wherein the selection circuit is configured to output the first pass control signal and the second pass control signal based on the selection signal, the first scan signal, and the second scan signal.

7. The light emitting diode display apparatus of claim 6, wherein the selection circuit is configured in each of the plurality of sub-pixels and the selection circuit includes a plurality of sub-selection circuits connected to the first pass control transistor and the second pass control transistor of the current path circuit which is configured in a corresponding sub-pixel among the plurality of sub-pixels, and
wherein each of the plurality of sub-selection circuits is configured to output the first pass control signal and the second pass control signal based on the selection signal, the first scan signal, and the second scan signal.

8. The light emitting diode display apparatus of claim 7, wherein the selection signal line includes a first selection signal line and a second selection signal line, and
wherein each of the plurality of sub-selection circuits includes:
a first selection circuit configured to output the first pass control signal based on a first selection signal supplied from the first selection signal line and the second scan signal; and
a second selection circuit configured to output the second pass control signal based on a second selection signal supplied from the second selection signal line and the first scan signal.

9. The light emitting diode display apparatus of claim 8, wherein the first selection circuit includes:
a first-first control node;
a first-second control node;
a first output node;
a first-first switching transistor turned-on based on the second scan signal, and the first-first switching transistor connected between the first selection signal line and the first-second control node;
a first-second switching transistor turned-on based on a voltage of the first-second control node, and the first-second switching transistor connected between a first driving voltage line and the first-first control node;
a first-third switching transistor turned-on based on a voltage of the first-second control node, and the first-third switching transistor connected between the first driving voltage line and the first output node;
a first-fourth switching transistor turned-on based on the second scan signal, and the first-fourth switching transistor connected between a second driving voltage line and the first-first control node;
a first-fifth switching transistor turned-on based on a voltage of the first-first control node, and the first-fifth switching transistor connected between the second driving voltage line and the first output node;
a first-first capacitor connected between the first-first control node and the first driving voltage line; and
a first-second capacitor connected between the first-second control node and the first driving voltage line.

10. The light emitting diode display apparatus of claim 8, wherein the second selection circuit includes:
a second-first control node;
a second-second control node;
a second output node;
a second-first switching transistor turned-on based on the first scan signal, and the second-first switching transistor connected between the second selection signal line and the second-second control node;
a second-second switching transistor turned-on based on a voltage of the second-second control node, and the second-second switching transistor connected between a first driving voltage line and the second-first control node;
a second-third switching transistor turned-on based on a voltage of the second-second control node, and the second-third switching transistor connected between the first driving voltage line and the second output node;
a second-fourth switching transistor turned-on based on the first scan signal, and the second-fourth switching transistor connected between a second driving voltage line and the second-first control node;
a second-fifth switching transistor turned-on based on a voltage of the second-first control node, and the second-fifth switching transistor connected between the second driving voltage line and the second output node;
a second-first capacitor connected between the second-first control node and the first driving voltage line; and
a second-second capacitor connected between the second-second control node and the first driving voltage line.

11. The light emitting diode display apparatus of claim 6, wherein the selection circuit is commonly connected to the first pass control transistor and the second pass control transistor of the current path circuit which is configured in each of the plurality of sub-pixels, and the selection circuit is configured to output the first pass control signal and the second pass control signal based on the selection signal, the first scan signal, and the second scan signal.

12. The light emitting diode display apparatus of claim 11, wherein the selection signal line includes a first selection signal line and a second selection signal line, and
wherein the selection circuit includes:
a first selection circuit configured to output the first pass control signal based on a first selection signal supplied from the first selection signal line and the second scan signal; and
a second selection circuit configured to output the second pass control signal based on a second selection signal supplied from the second selection signal line and the first scan signal.

13. The light emitting diode display apparatus of claim 12, wherein:
the first selection signal supplied from the first selection signal line has a high voltage level and a low voltage level alternating in units of frames; and
the second selection signal supplied from the second selection signal line has a voltage level different from the first selection signal among the high voltage level and the low voltage level.

14. The light emitting diode display apparatus of claim 13, wherein the first selection circuit includes:
a first-first control node;
a first-second control node;
a first output node;
a first-first switching transistor turned-on based on the second scan signal, and the first-first switching transistor connected between the first selection signal line and the first-second control node;
a first-second switching transistor turned-on based on a voltage of the first-second control node, and the first-second switching transistor connected between a first driving voltage line and the first-first control node;
a first-third switching transistor turned-on based on a voltage of the first-second control node, and the first-third switching transistor connected between the first driving voltage line and the first output node;
a first-fourth switching transistor turned-on based on the second scan signal, and the first-fourth switching transistor connected between a second driving voltage line and the first-first control node;
a first-fifth switching transistor turned-on based on a voltage of the first-first control node, and the first-fifth switching transistor connected between the second driving voltage line and the first output node;
a first-first capacitor connected between the first-first control node and the first driving voltage line; and
a first-second capacitor connected between the first-second control node and the first driving voltage line.

15. The light emitting diode display apparatus of claim 13, wherein the second selection circuit includes:
a second-first control node;
a second-second control node;
a second output node;
a second-first switching transistor turned-on based on the first scan signal, and the second-first switching transistor connected between the second selection signal line and the second-second control node;
a second-second switching transistor turned-on based on a voltage of the second-second control node, and the second-second switching transistor connected between a first driving voltage line and the second-first control node;
a second-third switching transistor turned-on based on a voltage of the second-second control node, and the second-third switching transistor connected between the first driving voltage line and the second output node;
a second-fourth switching transistor turned-on based on the first scan signal, and the second-fourth switching transistor connected between a second driving voltage line and the second-first control node;
a second-fifth switching transistor turned-on based on a voltage of the second-first control node, and the second-fifth switching transistor connected between the second driving voltage line and the second output node;
a second-first capacitor connected between the second-first control node and the first driving voltage line; and
a second-second capacitor connected between the second-second control node and the first driving voltage line.

16. The light emitting diode display apparatus of claim 7, wherein each of the plurality of sub-selection circuits includes:
a first connection line connected to a gate electrode of the first pass control transistor;
a second connection line connected to a gate electrode of the second pass control transistor;
a first output node and a second output node;
a first switching transistor turned-on based on the second scan signal, and the first switching transistor connected between the first connection line and the first output node;
a second switching transistor turned-on based on the first scan signal, and the second switching transistor connected between the second connection line and the second output node;
a first inverter circuit configured to supply to the first output node any one of a first driving voltage supplied from a first driving voltage line and a second driving voltage supplied from a second driving voltage line based on the selection signal;
a second inverter circuit configured to supply to the second output node any one of the first driving voltage and the second driving voltage based on the selection signal;
a first capacitor connected between a third driving voltage line and the first connection line; and
a second capacitor connected between the third driving voltage line and the second connection line.

17. The light emitting diode display apparatus of claim 16, wherein:
the data line configured in each of the plurality of sub-pixels is used as the selection signal line; and
the data line used as the selection signal line supplies the selection signal synchronized with any one of the first scan signal and the second scan signal to the selection circuit, and then supplies the data signal to the pixel circuit in a corresponding sub-pixel.

18. The light emitting diode display apparatus of claim 16, wherein the first inverter circuit includes:
a third switching transistor turned-on based on the selection signal, and the third switching transistor connected between the first driving voltage line and the first output node; and
a fourth switching transistor turned-on based on the second driving voltage, and the fourth switching transistor connected between the second driving voltage line and the first output node, and
wherein the second inverter circuit includes:
a fifth switching transistor turned-on based on the selection signal, and the fifth switching transistor connected between the first driving voltage line and the second output node; and
a sixth switching transistor turned-on based on the second driving voltage, and the sixth switching transistor connected between the second driving voltage line and the second output node.

19. The light emitting diode display apparatus of claim 11, wherein the selection signal is synchronized with the second scan signal in an N^{th} frame, and the selection signal is synchronized with the first scan signal in an (N+1)^{th} frame, wherein the N is a natural number.

20. The light emitting diode display apparatus of claim 19, wherein the selection circuit includes:
a first connection line connected to a gate electrode of the first pass control transistor;
a second connection line connected to a gate electrode of the second pass control transistor;
a first output node and a second output node;
a first switching transistor turned-on based on the second scan signal, and the first switching transistor connected between the first connection line and the first output node;
a second switching transistor turned-on based on the first scan signal, and the second switching transistor connected between the second connection line and the second output node;
a first inverter circuit configured to supply to the first output node any one of a first driving voltage supplied from a first driving voltage line and a second driving voltage supplied from a second driving voltage line based on the selection signal;
a second inverter circuit configured to supply to the second output node any one of the first driving voltage and the second driving voltage based on the selection signal;
a first capacitor connected between a third driving voltage line and the first connection line; and
a second capacitor connected between the third driving voltage line and the second connection line.
